(19) United States
(12) Patent Application Publication
(10) Pub. No.: US 2017/0262899 A1
(43) Pub. Date: Sep. 14, 2017

(54) Computing Mathematically-Optimized Properties for Paid Search

(71) Applicant: 360i LLC, New York, NY (US)

(72) Inventors: Michael Kevin Geraghty, Marietta, GA (US); Hua Ai, Atlanta, GA (US); Henry Beaver, Decatur, GA (US); Jason B. Bell, Atlanta, GA (US); Patrick D. Callow, Loganville, GA (US); Ye Chen, Atlanta, GA (US); Amit Dingare, Duluth, GA (US); Jonathan M. Donovan, Marietta, GA (US); Samuel Franklin, Atlanta, GA (US); Jason Hartley, Brooklyn, NY (US); Munehiro Nakayama, Tucker, GA (US); Lawrence Arthur O'Donnell, Atlanta, GA (US); Vu Pham, Atlanta, GA (US); Manoranjan Satapathy, Johns Creek, GA (US); Mehmet Eric Sonmezer, Atlanta, GA (US); Bruce Williams, Chicago, IL (US); Aleksey Yurchenko, Atlanta, GA (US)

(73) Assignee: 360i LLC, New York, NY (US)

(21) Appl. No.: 15/430,467

(22) Filed: Feb. 11, 2017

Related U.S. Application Data
(60) Provisional application No. 62/294,262, filed on Feb. 11, 2016.

(51) Int. Cl. G06Q 30/02; G06N 5/04

(52) U.S. Cl. CPC G06Q 30/0275; G06Q 30/0277; G06N 5/04

(57) ABSTRACT

A computer has a processor and nontransitory memory. The computer receives a list of search keywords to propose to a search engine. For search keywords that are too infrequently used to have historical data to estimate keyword performance, the computer computes linguistic similarity between the sparse-data keyword to other keywords that have sufficient historical keyword performance data to permit a statistically sound estimate for keyword performance. The estimates are submitted to a search engine, and updated by grouping the sparse-data keywords into groups, including at least a high-performing group and a low-performing group, and reallocating budget from the keywords of the low-performing group to keywords of the high-performing group, by reducing estimates for keywords of the low-performing group and increasing estimates of keywords of the high-performing group.

### BACKGROUND

This application is a non prov. of provisional of U.S. Provisional App. Ser. No. 62/294,262, filed Feb. 11, 2016, of Michael Kevin Geraghty et al., titled “Managing Online Paid Search Advertising,” incorporated by reference.

This application relates to optimization techniques for paid keyword searching on internet search engines.

When a user types a query into a search engine (such as Google, Yahoo, or Microsoft Bing), the search engine returns a page of results. For example, the search keyword “shirts” provided to Google may return a results page with a set of sponsored (paid advertising) links for various shirt retailers, before the “organic” (or “unpaid”) links. The position of the various paid ads within the total list of paid ads on the page is referred to as rank.

Google allocates the rankings by conducting an auction. Each advertiser places a bid for the maximum amount they are willing to pay for a click which is referred to as the Max CPC (Cost per Click). Google ranks the advertisers using a proprietary and opaque algorithm to compute a quality score. The quality score is Google's measure of the relevance of the ad and the quality of customer experience offered by the sponsored link. Ranking of ads is determined by the combination of the bid price and quality score.

### SUMMARY

In general, in a first aspect, the invention features a method. A computer has a processor and nontransitory memory. The computer receives a list of search keywords from an advertiser, and computes statistical linguistic similarity among the keywords, using a metric that gives greater weight to linguistic elements that are less frequent in the population of keywords, and balances for greater keyword length and redundancy. The computer groups the search keywords based on the assessed linguistic similarity, the grouping creating a hierarchical subset organization. For the search keywords that are frequent enough to have historical data from which to estimate advertising performance, the computer receives information relating to historical expenditure, proceeds, and click performance of advertising based on the search keywords, and computes bid prices for the search keywords for a budgeted operation period, the computation using convex constrained mathematical optimization techniques to locate a local maximum of a measure of advertising performance relative to variation in expenditure on search keywords, within a specified budget cap. For the search keywords that are too infrequently used to have historical data to estimate advertising performance, the computer computes linguistic similarity between the sparse-data keyword to other keywords that have sufficient historical advertising performance data to permit a statistically sound estimate for advertising performance. and computes a bid price for the sparse-data keyword based on the historical advertising performance data for keywords that are linguistically similar. After bids are submitted to a search engine for paid search for the sparse-data keywords, the bid prices for the sparse-data keywords are updated by grouping the sparse-data keywords into groups, including at least a high-performing group and a low-performing group, and reallocating budget from the keywords of the low-performing group to keywords of the high-performing group, by reducing bid prices for keywords of the low-performing group and increasing bid prices of keywords of the high-performing group. The computer, computes a tracking score that is designed to be a proxy for a quality score computed by a search engine, the search engine using the quality score to rank paid search advertisements for presentation to users, the tracking score being computed based at least in part on respective search keywords, ad creatives, landing pages for the keywords, and relevance between the ad creative and the content of the landing page. The computer presents the tracking score on a display screen to the advertiser, with diagnostic annotation to assist the advertiser in tailoring the ad creative and/or landing page to improve the search engine quality score and/or ranking of the creative among paid advertising results displayed by the search engine in response to the keyword.

In general, in a second aspect, the invention features a method. By computer, a list of advertising search keywords is evaluated by assessing statistical similarity among keywords. A measure of similarity uses a metric that gives greater weight to linguistic elements that are less frequent in the population of keywords, and balances for greater keyword length and redundancy. The computer groups the advertising search keywords based on the analyzed statistical similarity, for delivery to an internet keyword matching search engine.

In general, in a third aspect, the invention features a method. By computer, similarity among advertising search keywords in list of advertising search keywords are analyzed by decomposing the keywords of the list into n-grams of n letters, and analyzing the n-grams for linguistic similarity among pairs of keywords. The advertising search keywords are clustered based on the analyzed linguistic similarity, for delivery to a paid advertising interface of an internet keyword matching search engine.

In general, in a fourth aspect, the invention features a method. A computer receives a list of search keywords on which to bid for paid advertising at an internet search engine, and information relating to historical expenditure, proceeds, and click performance of advertising based on the search keywords. The computer computes an allocation of an advertising budget among the search keywords for a budgeted purchase period, the computation using convex constrained mathematical optimization techniques to locate a local maximum of a measure of advertising performance relative to variation in expenditure on search keywords, within a specified budget cap.

In general, in a fifth aspect, the invention features a method. A computer computes an analysis of performance of internet paid advertising over a period of time using a convex optimization model, the analysis programmed to identify at least one of the following: (a) recurring temporal variation in delivery of the advertising or of goods or services advertised by the advertising; and (b) nonlinear trends, being trends that increase or decrease nonlinearly over the period of time. The computer controls placement of advertising through paid search advertising at an internet search engine, based on results indentified by the analysis.

In general, in a sixth aspect, the invention features a method. A receives a list of search keywords on which to bid for paid advertising at an internet search engine, and information relating to historical expenditure, proceeds, and click performance of advertising based on the search keywords. The computer computes an allocation of an advertising budget among the search keywords for a budgeted purchase period, the computation seeking a local maximum of a measure of advertising performance relative to variation in expenditure on search keywords, within a specified budget cap.

In general, in a seventh aspect, the invention features a method. A computer receives a list of search keywords on which to bid for paid advertising at an internet search engine, and information relating to historical cost-per-click performance of advertising based on the search keywords. The computer computes a forecast of advertising impressions to be delivered and click-throughs of those impressions, the forecasting reflecting temporal variation in user response to the delivered impressions. The computer computes an optimization model of bid prices to be offered for the search keywords based on optimization modeling of at least the forecast of impressions, cost of the click-throughs.

In general, in an eighth aspect, the invention features a method. For advertising search keywords among a list of advertising search keywords that have historically been too infrequently used to have a statistically sound estimate for value, by computer estimating keyword value by assessing statistical similarity to other keywords that have a statistically sound estimate of value, a measure of similarity using a metric that gives greater weight to linguistic elements that are less frequent in the population of keywords, and balances for greater keyword length and redundancy. The computer submits bids to a search engine for advertising based on search of the infrequent keywords, at the computed bid price.

In general, in a ninth aspect, the invention features a method. A computer analyzes a list of advertising search keywords to be submitted to a search engine with bids for ranking among paid search advertising displays. For search keywords of the list for which historical advertising performance data is too sparse to permit a statistically sound estimate for advertising performance, a computer assesses linguistic similarity between the sparse-data keyword to other keywords that have sufficient historical advertising performance data to permit a statistically sound estimate for advertising performance, and computes a bid price for the sparse-data keyword based on the historical advertising performance data for keywords that are linguistically similar. After bids are submitted to a search engine for paid search for the sparse-data keywords, the bid prices for the sparse-data keywords are updated based on changes in the advertising performance data for linguistically-similar keywords.

In general, in a tenth aspect, the invention features a method.

601. A method, comprising the steps of:

by computer, analyzing a list of advertising search keywords to be submitted to a search engine with bids for ranking among paid search displays;

by computer, for search keywords of the list for which historical advertising performance data is too sparse to permit a statistically sound estimate for advertising performance:
assessing linguistic similarity between the sparse-data keyword to other keywords that have sufficient historical advertising performance data to permit a statistically sound estimate for advertising performance;
computing a bid price for the sparse-data keyword based on the historical advertising performance data for keywords that are linguistically similar;

after bids are submitted to a search engine for paid search for the sparse-data keywords, updating bid prices for the sparse-data keywords by grouping the sparse-data keywords into groups, including at least a high-performing group and a low-performing group, and reallocating budget from the keywords of the low-performing group to keywords of the high-performing group, by reducing bid price for keywords of the low-performing group and increasing bid price of keywords of the high-performing group.

In general, in a eleventh aspect, the invention features a method. A computer of a network computes a tracking score that is designed to approximate a quality score computed by a search engine, the quality score used by the search engine to rank content for presentation to users, the tracking score being computed based at least in part on respective search keywords, ad creatives, and landing pages. The computer presents to a user a series of reports, showing characteristics considered in computing the tracking score, with diagnostic annotation to assist the user in tailoring the landing page to improve the search engine quality score and/or ranking of the creative among paid advertising results displayed by the search engine in response to the keyword, the reports being arranged at two or more nested hierarchy levels.

In general, in a twelfth aspect, the invention features a method. A computer of a network computes a tracking score that is designed to be a proxy for a quality score computed by a search engine, the search engine using the quality score to rank paid search advertisements for presentation to users, the tracking score being computed based at least in part on respective search keywords and landing pages to be presented by the search engine on a search result page in response to the keywords. The tracking score is presented to an advertiser, with diagnostic annotation to assist the advertiser in tailoring the ad creative and/or landing page to improve the search engine quality score and/or ranking of the creative among paid advertising results displayed by the search engine in response to the keyword.

Specific embodiments of the invention may include one or more of the following features. A forecast of impression delivery may be computed to include temporal variation, for example, seasonal variation relating to a time of year, or day-of-week variation relating to day of the week. Temporal variation or cross-coupling between two trends may be identified by spectrum analysis is a product trend relationship. A recommended search-engine page rank may be computed for each keyword, and a budgeted bid for the keyword to achieve that rank. A spending cap for a subset of the keywords (up to and including the complete subset of all keywords) may be supplied, and the budgets computed to meet that spending cap. A computed allocation may include a set of bid prices to be offered to the internet search engine, the bid prices offered for respective ones of the search keywords. A measure of advertising performance to be maximized may include page rank, proceeds relative to expenditure. Price of advertising may be expressed in cost per click, or cost per impression. Proceeds to be optimized may be revenue, profits, income, net or gross. A subscore may reflect properties of a creative associated with the ad keyword, a click-through rate of a creative, or quality of a landing page. An opportunity index may be computed that indicates a focal point for tuning effort. Information may be presented as a time-varying graph.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### DRAWINGS

FIG. 1 is a block diagram of a computer system.

FIG. 2 is a flow chart.

FIG. 3 is a flow chart.

FIG. 4 is a block diagram of a system for optimizing a bid price for a search keyword.

FIGS. 5a to 5f are screen shots.

FIGS. 6a to 6g are screen shots.

### DESCRIPTION

The Description is organized as follows.

### I. Overview

### II. Automated Account Restructuring

II.A. Introduction and Overview

II.B. Components
II.B.1. Config.txt
II.B.2. Parameters.txt
II.B.3. Typedkeywords.txt
II.B.4. Brand.txt
II.B.5. Brandmisspelling.txt
II.B.6. Geo.txt
II.B.7. Category Files

II.C. Clustering Algorithm
II.C.1. Breaking Keywords into Trigrams
II.C.2. Generate a Measure of Linguistic Similarity
II.C.3. Clustering Software

II.D. Process and Results File

III. Allocation of Advertising Budget Among Keywords with Historical Data

III.A. Overview

III.B. Derivation

III.C. Modeling CPC and CTR
III.C.1. Impression Forecast

III.D. Vector and Matrix Generation

III.E. Computation of budget allocation values
III.E.1. Solution in Integer Programming
III.E.2. Solution as a convex optimization
III.E.3. Completing the Solution

III.F. The Auction Process

IV. Predictive Bidding for Keywords with Little Historical Data

IV.A. Inputs, Outputs, and Overview of Process

IV.B. Modified Kalman Filter

IV.C. Derivation in Support of the Maximum Likelihood equation

IV.D. Mean and Variance of Kalman Predictions

IV.E. Expectation Maximization with Maximum Likelihood Estimation

IV.F. Weighted Average of Bid Prices for Linguistically Similar Keywords

### V. Health Score

V.A. Overview

V.B. Inputs, outputs, process

V.C. Creative Subscore of the Health Score

V.D. Click-through Subscore

V.E. Landing Page Subscore

V.F. Health Score

V.G. Google's Quality Score

V.H. Rolling up the Subscores up the Ad/Ad Group/Campaign/Account Hierarchy

V.I. Opportunity Index

V.J. Graphical User Interface
V.J.1. Alerts
V.J.2. Hierarchical Performance Graphs
V.J.3. Pop-up Tips

V.K. Health Reporting Portal

### VI. Computer Implementation

### I. Overview

A computer system may be programmed to assist in formulating bids for keywords for paid search. An advertiser/client may specify a set of keywords (a few, sometimes over a million), and an overall budget. The computer system may analyze the keywords, and various factors relating to the keywords, for example, their past advertising performance, the performance of similar keywords, estimated conversions (that is, sales maturing from impressions or clicks), estimated revenue per conversion, and other factors, and may compute a preferred bid for submission to an internet advertising auction, for example, Google, Yahoo, or Microsoft Bing. The bid may be a maximum cost-per-click (CPC). The bid amount may typically be different for each keyword, because of different conversion rates and different revenue estimates for each click. For example, the keyword “blue socks” may have a high conversion rate of 5% but only makes a profit of $2 per sale. Because 5%*$2=$0.10, the maximum bid should be no more than 10 cents. A higher bid translates into a higher rank of the ad on a search result page, which translates into more clicks and thus more sales, but both the greater click rate and the greater bid price result in higher cost. The computer system may be programmed to take into account the various input data, and develop bid prices that improve some desired metric of proceeds, such as total sales, total profitability, or return on ad spend (which may, in turn, be computed in any of a number of ways, such as the ration of proceeds per click to the cost per click) across the set of keywords within the maximum budget.

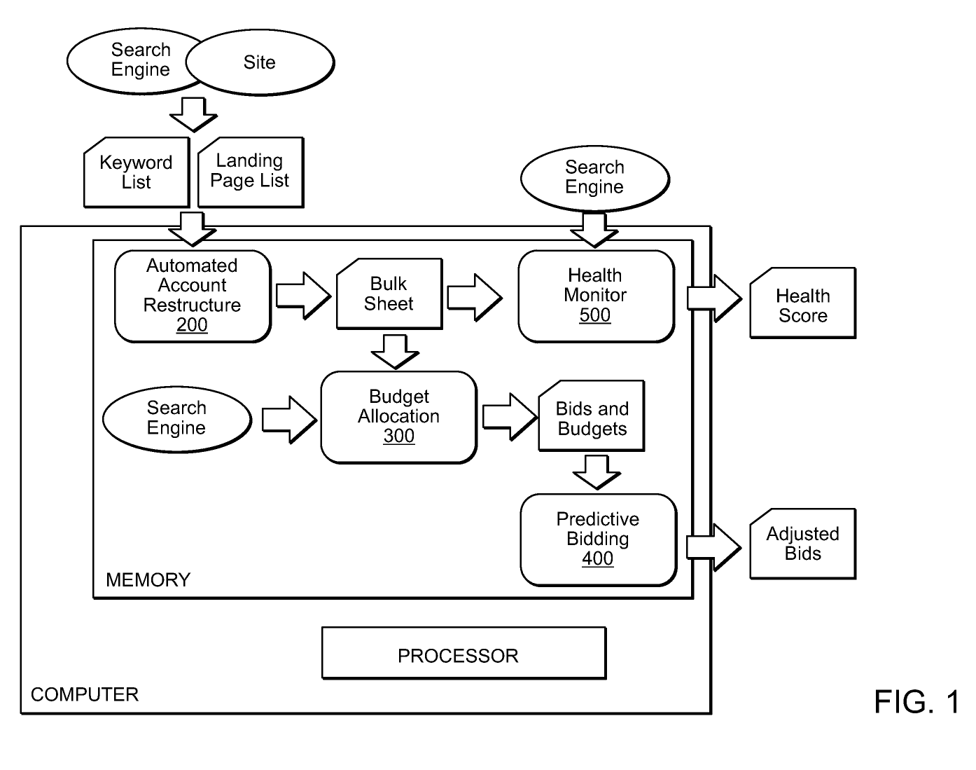

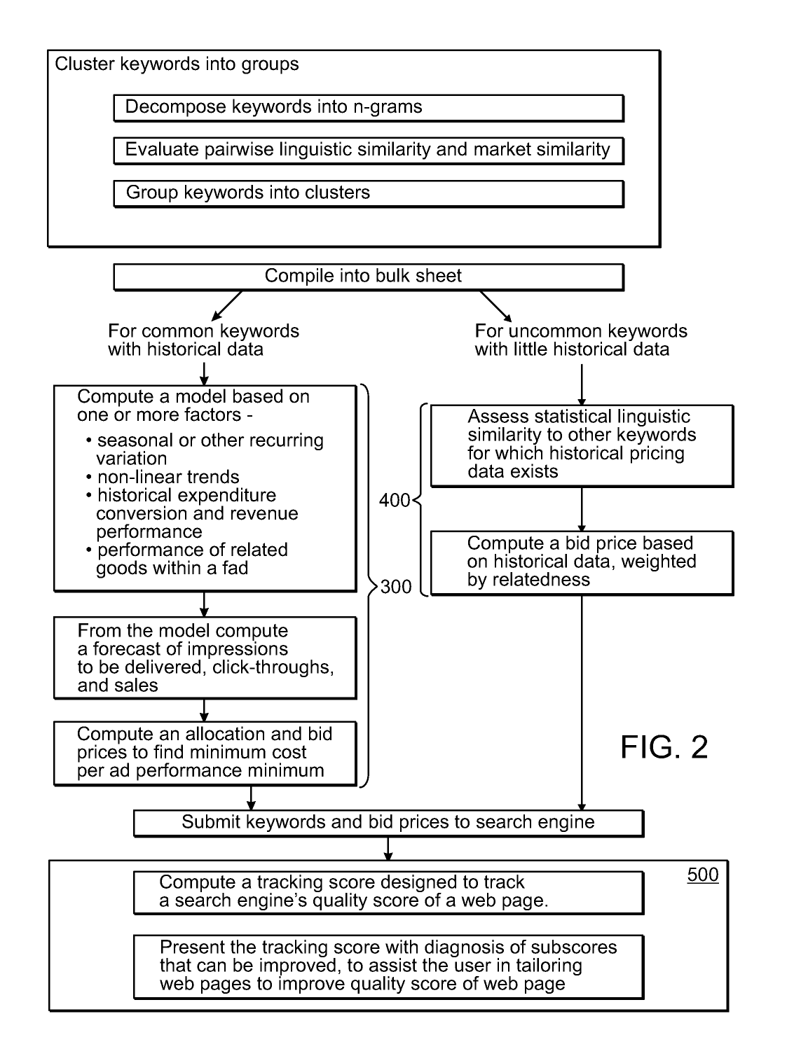

Referring to FIG. 1, four main components of the advertising management system include:
Automated Account Restructure Tool 200 (section II), for analyzing large keyword lists and organizing them into tractable categories
Forecasting and Budget Allocation (section III), for setting bid prices for most keywords based on statistical factors
Predictive Bidding (section IV), for setting bids for keywords that are clicked very infrequently, so that there is no direct statistical basis for setting the bid, and making real time adjustments to the bids computed by the Budget Allocation process
Account Health Monitoring (section V), for analyzing advertising performance and identifying areas that can be improved

Automated Account Restructure 200 receives keyword lists from either existing campaigns or sources such as web sitemaps and processes them into a bulk-sheet which communicates to the search engines the Paid Search account structure. Performance of an account is dependent on classifying keywords into a structure that aligns with customer search behavior. The development of a meta-language approach for including media manager intent into the Automated Account Restructure account partitioning decisions has meant that Automated Account Restructure tool 200 is a key driver of performance as well as media manager efficiency.

Once keywords have been assigned into a hierarchical structure of ad groups and campaigns, the keywords, ad groups, and campaigns need to be allocated budgets and bids. The Budget Allocation, and Predictive Bidding components may provide an optimization process for allocating an advertising budget among the keywords, ad groups, and campaigns that are optimal (in a computational modeling sense), and allow for variation in business models.

The bids that come out of the Budget Allocation process provide a good starting point for keywords that are clicked often enough to have a statistically-significant history. Predictive bidding provides the real time adjustments those bids, and for keywords that are clicked infrequently. Predictive Bidding may estimate return on ad spend for low volume keywords based on the performance of similar keywords and other keywords with linguistic similarities.

A Health Score system may analyze performance, both for reporting and to suggest diagnoses for improvement. The Health Score system may provide workflow management to focus media managers on the most important issues affecting a campaign in a proactive way, detecting issues with ad copy, click through rate and landing page performance, to improve the efficiency of advertising within the allocated budget.

### II. Automated Account Restructuring

### II.A. Introduction and Overview

An advertiser/client (for example, a retailer or other vendor) who has or is starting a program to buy paid search advertising (for example, from Google, Yahoo, or Microsoft Bing) may provide a list of keywords for which advertising is to be purchased. Lists may be hundreds of thousands of lines long, sometimes over a million, with very little internal structure.

In order to make an efficient advertising buy, and to permit ongoing monitoring and analysis of ad performance, it may be desirable to organize the keywords into groupings, for example, campaigns and ad groups. Automated account restructuring tool 200 may analyze a keyword list and produce a reorganized list, with the same keywords grouped by function. For example, automated account restructuring tool 200 might take an unordered list of search keywords—
blue socks
whitening toothpaste
sports logo hoodies
green socks
tartar control toothpaste
university hoodies
cotton socks
gel toothpaste
   and organize it into this organization:

Campaign Clothing:
Ad group socks:
   blue socks
   green socks
   cotton socks
Ad group hoodies:
   sports logo hoodies
   university hoodies

Campaign HBA
Ad group toothpaste
   whitening toothpaste
   tartar control toothpaste
   gel toothpaste

In one example organizational structure, an ad group may be a collection of keywords that share a common budget and a common bidding strategy, and a campaign may be a collection of ad groups that align with a subset of an advertisers products or services or a common messaging strategy.

In some cases, account restructure tool 200 may take the following inputs:
the keyword list. If no list of keywords is readily available from an existing implementation of the account, keywords may be generated from a list of products the advertiser/client sells, from the organization of a paper catalog, from a website which presents their products, or the like.
a high-level account structure/taxonomy, the “buckets” into which the keywords will be sorted
various control and “hint” files, discussed in section II.B, below

In some cases, the sorting and grouping of keywords may be based on linguistic similarity among keywords, perhaps further guided by linguistic similarity to the initial high level account structure. Grouping into campaigns and ad groups may also be based on factors including but not limited to expected searcher intent, advertiser products and services which the keywords may refer to, and advertiser messaging. Partitioning may be based on mathematical clustering techniques which minimize variation within campaigns and ad groups.

Additionally, account restructuring may group keywords and ad groups based on landing pages. (When an advertiser/client buys paid search advertising, the advertiser/client specifies a “landing page” to be associated with the keyword, so that when the user clicks on an ad on a search results page, the user is directed to the specified landing page.) When a searcher clicks on the sponsored link the landing page will be served in the searchers browser. Assignment may be based on linguistic similarity of landing page content to keywords and expected performance of ad groups based on landing page characteristics such as landing page response time and landing page intent.

Once the keywords are grouped, they may be deployed in the search engine to be served to searchers. Account Restructure Toolkit 200 may output a formatted file referred to as a Bulk Sheet, formatted to be fed directly into a search engine's keyword auction tool or ad manager (such as Google Adwords). A Bulk Sheet provides instructions to the search engine, to associate keywords with ads to display in response to the keywords, and landing pages to which to direct the searcher in the event that the searcher clicks on the ad.

Imposing an organization may be important for purposes of allocating costs to the client/advertisers internal cost accounting, to analyze cost-to-benefit for keywords, to set bidding levels for keyword auctions, to set budget for the group (as opposed to setting a budget for each individual keyword or the entire account), etc.

The input list may be less-than-ideally organized for any number of reasons. For example, a keyword list may have been assembled over many years by many people acting without coordination. The keyword list may have been harvested automatically from one or more web sites, or may have been assembled from multiple sources that did not have a common taxonomical organization. The list may have an organization, but when the advertiser/client moves from one advertising agency to another, the old organization may not be a good fit for the new agency's practices. The advertiser/client may have changed brand messaging, website configuration, or retail strategy (for example, when J.C. Penney discontinued coupons), and the structure of the keywords may need to change to reflect those changes. As users' use of keywords changes (for example, as keywords become longer to do more specific searches), search engines' matching logic changes, and the keyword organization may need to change as well.

Automated account reorganization tool 200 may offer the following advantages:
1. Google adwords allows designation of a budget for an ad group, and allows the budget to be spent fluidly among all keywords of the keyword group. Accurate grouping of ad keywords may improve efficiency of targeting advertising to users and efficient use of an advertising budget.
2. Reduction in manual effort required to manage an advertising account. Some advertisers/clients have keyword lists with greater than 1 million keywords, so management by a human is problematic.
3. Consistency for campaign and ad group formation across an advertising agency, which permits the agency to tune its processes across fewer variations.
4. Tightly cohesive ad groups, in which each keyword in an ad group will be highly relevant to the ad and landing page associated with the ad group. That means the search engine will be more favorably disposed to show the ad, and that the advertiser will pay less for each click.
5. Account structures created by an automated tool may be more targeted to geography, so that an ad is shown more often to geographically-relevant users, and less often to users that are not within the geographic scope of the advertiser/client's business. For a brick-and-mortar retailer, keywords that are associated with a particular location may be grouped together, so that the ad group can be targeted to searches that arise in the catchment area of the retailer's location.
6. Ad groups created by an automated tool may likewise be more targeted to particular submarkets and consumers. For example, an ad group containing the names of camera accessories will be more effective if the model of the camera is used to tie the ad group together, rather than an ad group for a particular type of accessory. The searcher for camera accessories is most likely interested in buying accessories for a particular camera. The search engine will discover from the click through rate that the relevance of the camera model oriented ad group is higher if the ad copy and landing page are specific to the camera model.
7. If advertiser/client adds new products or change brand messaging or website configuration, Account Restructure Toolkit 200 may be used to update the account structure to accommodate those changes.

### II.B. Components

Account Restructure Toolkit 200 may accept the following inputs:
Control files that provide an initial high level campaign structure and instructions to Account Restructure Toolkit 200 on how to reprocess that structure.
A campaign structure meta-language.
Keyword lists in text files such as Typedkeywords.txt
A clustering process which assigns keywords from the comprehensive list to campaigns and ad groups based on linguistic similarity.

The initial step in Account Restructure Toolkit 200 process may assign keywords to categories according to a high level structure expressed in the config.txt file. Account Restructure Toolkit 200 may accept the following input files:
Control Files
   Config.txt
   Parameters.txt
Keyword Files
   Typedkeywords.txt
   Brand.txt
   Brandmisspeling.txt
   Geo.txt

In addition optional files containing lists of keywords may include Competitor.txt or Category files. In order for the keywords from these files to be included in processing they must be referenced in the conf.txt file.

II.B.1. Config.txt

The config.txt file provides a high level account structure. This structure may be expressed through an account structure meta-language, for example a language that recognizes four control symbols:
‘*’ for branching to a keyword level
‘**’ for branching to modifications to a keyword level entry
‘|’ for concatenation and exclusion of non-concatenated versions of paired strings
‘̂’ for negation

Branching logic may implement the following rules:
If a line begins with an alpha-numeric character and not one of the control symbols, then that line represents a category and the initial character string up until a space or tab delimiter is the name of the category.
If a category line contains a second text string after the category name and the space or tab delimiter that text string is the name of a text file containing keywords which will be included in the category.
If a line begins with a single ‘*’ that line indicates an entry in the category. The following text will be pattern matched to generate keywords.
If a line begins with ‘**’ that line indicates a modifier to the preceding keyword entry.
A keyword modification line, which begins with ‘**’, cannot immediately follow a category name line. It must follow a keyword entry line which begins with a single ‘*’
A keyword modification line does not have to immediately follow a keyword entry line. The keyword modification line applies to the closest keyword line that precedes it.

Account Restructure Toolkit 200 may associate each category with a set of keywords. These keywords can be identified by a series of entries following the category where each line starts with an ‘*’ or by providing the name of a file containing keywords next to the category name. The entries with leading ‘’'' below a category name will be pattern matched to the keywords in the Typedkewords.txt file. If the campaign name is followed by a text file name, the keywords from that file name may also be included under the category.

The following table is a set of lines from a “config.txt” file that illustrates three major categories: “Competitor,” “Brand,” and “Nonbrand:”

| | |
|---|---|
| 1 | Competitor Competitor.txt |
| 2 | *teeth pa |
| 3 | *tooth Pa |
| 4 | Brand Brand.txt |
| 5 | *tooth pa |
| 6 | *teeth pa |
| 7 | Nonbrand |
| 8 | *tooth pa |
| 9 | **whiten |
| 10 | **gel |
| 11 | **tartar \hat{ }sens |
| 12 | **sens \hat{ }flou \hat{ }floor |
| 13 | **floor |
| 14 | **flour |
| 15 | *gel |
| 16 | **white |
| 17 | *was |
| 18 | **\|fresh\|breath\| |
| 19 | **breath \hat{ }bad \hat{ }foul \hat{ }smell |
| 20 | |

As an example of the config.txt logic, the single leading ‘*’ on line 8 refers to any non-brand keyword containing “teeth pa” and line 9 groups any keyword that contains “teeth pa” and “whiten”. The keywords from the Typedkeywords.txt file that match these criteria will be included in the non-brand category.

Using “*” wildcarding to truncate keywords in the config.txt file may help handle misspelling and other variations. For example, in line 17, the “was” is likely for “wash” as in mouth wash, but incorporates typos or misspellings (e.g. if a searcher mistypes ‘wash’ as “wassh” the paid search ad will still match to the search).

The “̂” indicates negation. For example, in line 19, an advertiser may with to bid for positive breath words, but not words like “bad breath” “foul smelling breath”, etc.

The “|” (pipe symbol) in line 18 “|Fresh|Breath|” indicates that Account Restructure Toolkit 200 should look for the phrase “fresh breath” not the individual words “fresh” and “breath.” The pipe symbol will also stop “breath” from being seen as a piece of a longer word like “breather”.

Under the category “Nonbrand” the first branch is “tooth pa” (i.e., for tooth paste), and the second branch represents keywords that are about tooth paste AND whitening (e.g., “whitening tooth paste”). In a further example with
*tooth pa
**tartar̂sens

This represents a keyword that has “tooth pa” AND “tartar” but NOT “sens” so,
“tartar prevent tooth paste” will be included
“sensitive tooth paste tartar protect” will not be included
   If a keyword has the first branch “tooth pa” but not any of the subsequent branches it will still get categorized under “tooth pa”.

Instead of or in addition to a list of individual words, account restructure tool 200 may take as input .txt files full of words, like brand names. These can be called at any branch of the tree, and have the following format
filename→filename.txt (where the → indicates a tab divider) for example:

brand brand.txt
If this were a on a lower branch an example would be:

**brand brand.txt

II.B.2. Parameters.txt

Parameters.txt controls the keyword size of the groupings. The entries are as follows:
Minimum number of keywords for initial bucketing to run
Minimum number of keywords for clustering to run
Minimum number of keywords for clustering to use linguistic processing
Ideal number of keywords in each cluster
   Lower bound
   Upper bound
   Ideal cluster size

Parameters.txt can be modified for a re-run of Account Restructure Toolkit 200 to change the size or number of ad groups.

II.B.3. Typedkeywords.txt

Typedkeywords.txt is a file containing a comprehensive keyword list including keywords sourced from at least some of the following:
1. Current keywords in the account that will continue to be in use after the restructure.
2. A list of the current keywords from a search query report from the search engines
3. Optional 3^{rd} party keyword sources (for example, Google Adwords Keyword Planner)

Other initial files that the Account Restructure Toolkit checks for, but may be empty include:

II.B.4. Brand.txt

Brand.txt is a list of all brand keyword iterations. This list will include shortened versions to account for typos and variations.

II.B.5. Brandmisspelling.txt

Brand misspeling.txt stores all brand keywords and misspellings. If there are two brand files e.g., brand_core.txt and brand_non_core.txt, terms from both files should be included here. If there are no entries for this file it should be left blank, but still needs to exist.

II.B.6. Geo.txt

Geo.txt in its default configuration is a list of the 50 states, state abbreviations and top 150 cities by population. It serves as identifying file for geo-modified keyword strings. “Where to Buy Crest in Georgia” or “Procter Gamble OH”. It can be manually modified to add or remove client specific geographic text.

In addition to required files, optional files may be provided to the Account Restructure Toolkit and referenced from the config.txt file.

II.B.7. Category files

Category files may provide keyword lists similar to brand.txt or competitor.txt, but with specific keyword groupings that should be used together. For example, if the client is a jewelry store, there may be input category files such as ring.txt, bracelet.txt, and earring.txt, which would have different words associated with these categories.

### II.C. Clustering Algorithm

Account Restructure Toolkit 200 may analyze linguistic similarity by any of several algorithms. For example, a trigram clustering algorithm (see §II.C.2) may determine linguistic similarity. One example family of linguistic similarity/clustering algorithms may include steps as follows:
1. Break each keyword into trigram tokens
2. For each pair of keywords in the batch of keywords to be clustered, generate the linguistic similarity measure
3. Apply the clustering software to divide the batch of keywords into clusters

II.C.1. Breaking Keywords Into Trigrams

A keyword is a combination of characters representing one or more English (or other) language words separated by spaces. The batch of keywords that are to be clustered may be determined by the initial bucketing algorithm. A batch of keywords may correspond to a category or subcategory that has enough keywords to justify applying the clustering algorithm based on the clustering parameter in the parameters.txt file.

The trigram matching algorithm may begin by breaking each keyword into multiple three-character tokens. The process may start by splitting each keyword into its separate words. For each word, each set of three consecutive letters becomes one token. Two additional tokens may be created for each word, one containing just the first character of the word (appended with a # sign), and one containing just the first two characters of the word (appended with a ! sign). This puts additional weight towards the overall matching percentage to the start of each word. Finally, one additional token may be added containing the first letter of two consecutive words, separated by a space.

For example, the full list of tokens for the “princess cut formal gowns” keyword may be:

p#, pr!, pri, rin, inc, nce, ces, ess, c#, cu!, cut, f#, fo!, for, orm, rma, mal, g#, go! gow, own, wns, p c, c f, f g

The full list of tokens for the keyword “formal evening gowns” may be:

f#, fo!, for, orm, rma, mal, e#, ev!, eve, ven, eni, nin, ing, #g, go!, gow, own, wns, f e, e g

II.C.2. Generate a Measure of Linguistic Similarity

The set of trigrams derived from a keyword may be compared to the set of trigrams generated from another keyword to define a measure of linguistic similarity. One implementation of the account restructure model creates a measure of linguistic similarity between each long tail keywords and all keywords in the related cluster. One implementation of a measure of linguistic similarity is to compare tokens (e.g., trigrams or n-grams) between keywords, which may also be referred to as search queries, as follows:

Assume that there are two search queries;

P={p₁, p₂ . . . , pₘ} with m tokens

R={r₁, y₂ . . . , yₙ} with n tokens

and n≧m, otherwise we switch P and R.

F(t): Number of occurances of token t within the batch

N: Total number of keywords included in the batch

Weight for token t defined as:

$${Weight}_{t} = ln ( \frac{F ( t )}{N} )$$

Sum of the weights of tokens shared between the two keywords, Weight_{IP∩RI}, is defined as:
If pᵢ=rⱼ

Weight IP∩RI=Sum of Weight (pᵢ) where i runs from 1 to m
If pᵢ≠rⱼ

Weight_{IP∩RI}=0

or

$${Weight}_{\vert P ⋂ R \vert} = \{ \begin{matrix}{\sum }_{i = 1}^{m} {Weight}_{{p}_{i}} , & if {p}_{i} = {r}_{j} \\ 0 , & if {p}_{i} \neq {r}_{j}\end{matrix}$$

Union of the weights of tokens for P and R defined as:

Weight_{IP∪RI}=Weight_{P}+Weight_{R}−Weight_{IP∩RI}

One implementation of linguistic similarity between words P and R is defined as:

$$RC ( P , R ) = \frac{{Weight}_{\vert P ⋂ R \vert}}{{Weight}_{\vert P ⋃ R \vert}}$$

This measure of similarity is appropriately sensitive to the length of the two keywords (as opposed to some measures that are not, for example measures of correlation between a keyword and a web page, that are not sensitive to the length of the page). The measure should not have undue preference for longer keywords, to avoid over-preference for similarity between longer keywords simply because of the greater length, or because a subphrase is repeated multiple times.

Likewise, this measure of similarity has a denominator that adjusts for length of the keywords, without skewing for repetition of a subphrase. This measure also appropriately gives greater weight to less common words, and gives less weight to non-important words, words that commonly overlap between any two keywords, like “the.”

Other algorithms for measures of linguistic similarity may be based on n-gram approximate string matching which may be found at:

https://en.wikipedia.org/wiki/N-gram#n-grams_for_approximate_matching

and

https://cran.r-project.org/web/packages/stringdist/stringdist.pdf

Other approximate string matching or linguistic similarity algorithms not based on n-grams may also be used. For example, several methods are discussed in Chris Manning and Hinrich Schütze, Foundations of Statistical Natural Language Processing, MIT Press, Cambridge, Mass. (May 1999) (incorporated by reference), which describes five different measures of overlap coefficient:
Matching Coefficient |P∩R|: the number of terms appearing in both vectors.
Dice Coefficient

$$\frac{2 * \vert P ⋂ R \vert}{\vert P \vert + \vert R \vert} \text{:}$$

the number of terms appearing in both vectors with respect to the length of the two vectors.
Jaccard Coefficient

$$\frac{ \vert P ⋂ R \vert}{\vert P ⋃ R \vert} \text{:}$$

the number of terms appearing in both vectors with respect to the length of the two vectors but also takes into account low-overlap cases by giving them a lower value.
Overlap Coefficient

$$\frac{ \vert P ⋂ R \vert}{min ( \vert P \vert * \vert R \vert )} \text{:}$$

the number of terms appearing in both vectors with respect to the length of the smaller of the two vectors.
Cosine

$$\frac{ \vert P ⋂ R \vert}{\sqrt{\vert P \vert + \vert R \vert}} \text{:}$$

this measure acts as the Dice Coefficient but it penalizes less if the lengths of the two vectors are very different.

For the example pair of keywords P=“princess cut formal gowns” and R=“formal evening gowns,” the following trigram tokens match:

| | Trigrams | | | | | | | | | | | | | |
|---|---|---|---|---|---|---|---|---|---|---|---|---|---|---|
| Search Queries | 1 | 2 | 3 | 4 | 5 | 6 | 7 | 8 | 9 | 10 | 11 | 12 | 13 | 14 |
| formal evening gowns | f# | fol | for | orm | rma | mal | e# | evl | eve | ven | eni | nin | ing | g# |
| princess cut formal gowns | p# | prl | pri | rin | inc | nce | ces | ess | c# | cul | cut | f# | fol | for |
| \|PGR\| | | | | | | | | | | | | f# | fol | for |

| | Trigrams | | | | | | | | | | | |
|---|---|---|---|---|---|---|---|---|---|---|---|---|
| Search Queries | 15 | 16 | 17 | 18 | 19 | 20 | 21 | 22 | 23 | 24 | 25 | Count of Trigrams |
| formal evening gowns | gol | gow | own | wns | f e | e g | | | | | | 20 |
| princess cut formal gowns | orm | rma | mal | g# | gol | gow | own | wns | p c | c f | f g | 25 |
| \|PGR\| | orm | rma | mal | g# | gol | gow | own | wns | | | | 11 |

For these two keywords, the five linguistic similarity measures are as follows:

| | | Semantic |
|---|---|---|
| Semantic Similarity Method | Definition | Similarity Score |
| Matching Coefficient | \|P∩R\| | 11 |
| Dice Coefficient | 2 * \|P∩R\|/(\|P\| + \|R\|) | 0.49 |
| Jaccard Coefficient | \|P∩R\|/\|P∪R\| | 0.32 |
| Overlap Coefficient | \|P∩R\|/min(\|P\|, \|R\|) | 0.55 |
| Cosine | \|P∩R\|/SQRT(\|P\| * \|R\|) | 0.49 |

A sixth measure of linguistic similarity is the Normalized Google Distance (NGD), described in R. L. Cilibrasi, P. M. B. Vitanyi, The Google Similarity Distance, IEEE Trans. Knowledge and Data Engineering, 19:3 (2007), 370-383 (incorporated by reference). The NGD relatedness between words P and R is defined as:

$$NGD ( P , R ) = \frac{max ( ln D ( P ) , ln D ( R ) ) - ln D ( P , R )}{ln N - min ( ln D ( P ) , ln D ( R ) )}$$

where

D(wᵢ): Number of web documents having word wₙ

D(wᵢ, wⱼ): Number of web documents having bot word wᵢ and wⱼ

N: Total number of web documents used in

Bounded (in between 0 and 1) NGD relatedness is defined as:

NGD¹(R,R)=e^{-2*NGD(P,R)}

The linguistic similarity for each batch may be stored in a distance file. Since most correlations will be near zero, a sparse matrix representation may be appropriate. For example, for the keyword pairs with correlation significantly above zero, a distance file may be built with the following triples:
Keyword 1
Keyword 2
Linguistic Similarity
   The distance file may provide the distance measure for each keyword pairing in the batch of keywords for the clustering algorithm

II.C.3. Clustering Software

Once pair-wise correlations are assessed, Account Restructure Toolkit 200 may use a clustering algorithm to assemble clusters of correlated keywords into ad groups, clusters of correlated ad groups into campaigns, and the like. One clustering algorithm is provided by Cluto (http://glaros.dtc.umn.edu/gkhome/fetch/sw/cluto/manual.pdf). The standalone vCluto software program may be applied to a batch of keywords at either the category or subcategory level (described in §II.D below). vCluto also requires parameters that indicate the size of the clusters which are derived from the parameters.txt file. vCluto will then return a partitioned list of keywords in a tree structure that indicates the category and subcategory that each keyword is assigned to.

### II.D. Process and Results File

Account Restructure Toolkit 200 may perform the following steps:
Initial bucketing based on high level account structure expressed in config.txt
Clustering based on linguistic similarity
Development of account structure based on parameters in parameter.txt file

The initial bucketing process of Account Restructuring Toolkit 200 may evaluate the contents of config.txt file and interpret the meta-language instructions.
1. Bucketing ingests the comprehensive keyword list in Typedkeywords.txt
2. For each category in config.txt that has a keyword list file associated with it
   a Search Typedkeywords.txt file for the presence of the keyword from the keyword list file.
   b If the keyword is found in Typedkeywords.txt, assign it to the category indicated in the config.txt file
   c If the keyword is not found in the Typedkeywords.txt file, remove it from consideration
3. For each category in the config.txt file that has a meta-language processing instructions
   a Process Typedkeywords.txt according to meta-language rules
   b Allocate each keyword that conforms to the meta-language description to the category
   c Allocate each keyword that conforms to keyword modification description to sub-categories within the category
4. Create a temporary category to keyword mapping file
5. If parameter file indicates clustering conditions are not met, terminate process. The temporary category to keyword mapping file becomes the output.txt results file.
6. If sufficient keywords are present according to criteria in the parameters.txt file initiate clustering.

A batch of keywords may be passed to the clustering process. The clustering process may create subgroups of keyword batch from the contents of the temporary category to keyword mapping file based on linguistic similarity:
7. Clustering ingests the category to keyword mapping file and reads each category and subcategory sequentially.
8. If the category contains sub-categories, process each subcategory sequentially as a batch.
9. Where the sub-category has sufficient keywords for further clustering, based on parameters specified in parameters.txt, apply the clustering process to the subcategory. This creates multiple sub-categories to replace the single subcategory. Retain the category-to-subcategory mapping and extend it to the new subcategories.
   a Where the category does not contain subcategories and the category has sufficient keywords for further clustering, based on parameters specified in parameters.txt, apply the clustering algorithm to the category as a keyword batch. Create multiple sub-categories to replace the single category. Create a category to subcategory mapping.
10. Produce a results file which contains the following fields:
   a Keyword—the list of keywords matches the list from the TypedKeyword.txt file
   b Subcategory—this will be implemented as the ad group in the search engine account structure.
   c Category—this will be implemented as the campaign in the search engine account structure.

The results file from Account Restructuring Toolkit 200 becomes the basis for the search engine bulk sheet once the file has been reviewed and modified by the media manager to conform to the specific formats required by the search engine. The bulk sheet is implemented in the search engine through an upload process provided by the search engine's management software.

### III. Allocation of Advertising Budget Among Keywords with Historical Data

A Budget Allocation component may assign budgets to advertising keywords, based on forecasting search query volume (also referred to as impressions), modeling the impact of rank on the click through rate (CTR) and cost per click (CPC) of a keyword. Budget may be assigned to each keyword in order to improve economic performance of ads, based on the expected number of impressions, the CTR and CPC models and the client's total budget.

### III.A. Overview

The goal is to find a cost-per-click bid amount or a maximum cost-per-click bid or other bid for advertising opportunity on a search engine, for each keyword for each day so that the impact of the advertising will be improved per unit of outlay for the advertising, and that the advertising campaign as a whole will exactly use up the allocated budget, and use it up exactly at the end of the budget period, and the end of each day t. An ad impression need not appear at rank 1 to be effective; many ads are more cost-efficient but still have sufficient consumer influence if they appear at lower ranks. If the budget is exhausted before the end of the day, the bid was too high during the early part of the day and the sales made were made at a higher-than-necessary cost, and opportunities were lost later in the day. If budget remains, the bids were too low, and opportunities were lost to advertise for profitable business. The Budget Allocation process 300 of this section III computes a maximum cost-per-click value or other bid metrics for keywords with statistically-significant performance; the actual price paid may be determined by the auction protocol of the search engine, as described in section III.F, below. The Predictive Bidding process of section IV, below, fills in gaps for low-probability, long-tail keywords.

The “rank” of a keyword refers to the position an advertiser's ad attains among the sponsored links of other advertisers for the same (or similar) keywords, delivered as part of a page of search hits delivered by a search engine. In general, ten sponsored links are presented on the first viewable page of the results page, a further ten are presented on the next page and so on. Thus, an ad with rank 1-10 will be on the first page of search results (in the list of paid search ads at the top of the page), an ad with ranks 11-20 will be on the next page, and so on. Note that the “rank” among paid search results is different than the page rank among the organic search results. Thus, the goal of setting bidding amounts is to set a price that (when considered along with all the other variables that go into ranking ads) results in an ad achieving a desired rank among all other paid search ads. Search engines do not report results of individual searches, only at an aggregate level: for example, the search engine may report average rank during hourly or daily periods, along with the total number of impressions delivered by the search engine, and the number of click-throughs resulting from those impressions.

The budget allocation produces outputs, that are to be fed into the search engine's paid search keyword bid interface:
Max CPCₖₜ=maximum cost per click for each keyword k on day t, for each k keyword in the list of keywords to bid on during day t (a future date) during the bidding budget period
Sₖₜ(xₖₜ)=cap on spend for keyword k on day t.
   from inputs of historical measured values.

A first group of inputs comes from the advertiser:
the list of keywords (for example, derived by the Account Restructure Tool 200 of section II, above).
RPCₖₜ=Revenue per click, which varies by day and keyword but is independent of rank. (Revenue in this context may be marginal profit, that is, price per unit sold less cost of goods sold, rather than top line revenue)
MaxSpend=total spend limit across all keywords for the budget period's planning horizon.

Other inputs includes data gathered by the search engine about past advertising performance and made available to the advertiser:
CTRₖₜ(xₖₜ)=Click through rate of keyword k at rank x, that is, the historical rate of click-throughs for the keyword when the advertiser's bid and the landing page quality score for the keyword has been high enough for the advertiser's ad to attain rank x on date t (in the past)
CPCₖₜ(xₖₜ)=Cost Per Click of keyword k at rank x.

The number of “impressions” for an ad is the number of times that the ad copy was displayed on a search results page in response to a keyword search. Not every search for the keyword results in an impression, for a variety of reasons: for example, the budget for this ad may be exhausted. An “impression” occurs if the ad is presented on any search result page, whether or not the user navigates to that part of the results page, or clicks on the ad. For example a sponsored link may have rank 14 and be included on the second page of search results. In this case an impression is said to have occurred whether or not the searcher navigates to the second page. A count of aggregate impressions is reported by the search engine at the same level as average rank.

### III.B. Derivation

The budget allocation problem may be modeled mathematically. One example model is as follows. In addition to the input and output variables listed above, the following variables may be computed or used in the model:
k=keyword
t=day (or hours, in cases where that is warranted), either a future day in the planning horizon for bidding, or a past day in the historical data. Since allocations are daily, often the following discussion drops the t subscript for readability. However, the implementation computes results for individual days.
xₖₜ=Rank of keyword k on day t. This is our decision variable.
Impₖₜ=Forecast of impressions varies by day and keyword but is independent of rank.

The budget allocation tool may allocate budget among (keyword, day) pairs in order to maximize revenue after the cost of advertising:

$$Maximize {\sum }_{k , t} {Revenue}_{kt} - {Spend}_{kt}$$

subject to a maximum, MaxSpend, during the planning horizon.

$${Revenue}_{kt} = {RPC}_{kt} * {CTR}_{kt} * {IMP}_{kt}$$

$${Spend}_{kt} = {CPC}_{kt} * {CTR}_{kt} * {IMP}_{kt}$$

$$Maximize {\sum }_{k , t} {RPC}_{kt} * {CTR}_{kt} * {IMP}_{kt} - {CPC}_{kt} * {CTR}_{kt} * {IMP}_{kt}$$

Impressionₖₜ is found in both terms so equivalently

$$Maximize {\sum }_{k , t} {RPC}_{kt} * {CTR}_{kt} - {CPC}_{kt} * {CTR}_{kt}$$

Subject to the constraint that

$${\sum }_{k , t} {S}_{kt} \leq MaxSpend$$

However the constraints and the objective function are not expressed in terms of the decision variable, which is rank (x). Note that rank for any keyword corresponds to a specific cost per click and click through rate. The Budget Allocation process may model CPC and CTR as exponential curves for each keyword in terms of rank ‘x’ as follows:

CPCₖ=aₖe^{b}^{ₖ}^{*x}

CTRₖ=cₖe^{d}^{ₖ}^{*x}

So each keyword has an exponential curve with two parameters aₖ and bₖ for CPC and an exponential curve with two parameters cₖ and dₖ for CTR. In the optimization problem these curves do not vary over time so the two previous equations simplify to:

CPC_{k,t}=CPCₖ

CTR_{k,t}=CTRₖ

for all t. Now the terms in the optimization formulation may be expressed in terms of rank xₖₜ of each keyword on each day:

$$Maximize {\sum }_{k , t} {RPC}_{kt} * {c}_{k} {e}^{{d}_{k} * {x}_{kt}} - {a}_{k} {e}^{{b}_{k} * {x}_{kt}} * {c}_{k} {e}^{{d}_{k} * {x}_{kt}}$$

subject to:

$${\sum }_{k , t} {a}_{k} {e}^{{b}_{k} * {x}_{kt}} * {c}_{k} {e}^{{d}_{k} * {x}_{kt}} * {IMP}_{kt} \leq MaxSpend$$

Simplifying a bit:

wₖe^{z}^{ₖ}^{*z}^{ₖₜ}=aₖe^{b}^{_{y}}^{*x}^{ₓₓ}≠cₖe^{d}^{_{y}}^{*x}^{ₖₜ}

where

wₖ=aₖ*cₖ

zₖ=bₖ+dₖ

Let vₖₜ be defined as follows:

vₖₜ=RPCₖₜ*cₖ

And substitute into the earlier maximization expression:

$$Maximize {\sum }_{k , t} {v}_{kt} {e}^{{d}_{k} * {x}_{kt}} - {w}_{k} {e}^{{z}_{k} * {x}_{kt}}$$

subject to:

$${\sum }_{k , t} {w}_{k} {e}^{{z}_{k} * {x}_{kt}} * {IMP}_{kt} \leq MaxSpend$$

The output of the optimization is a set {xₖₜ} which is the recommended rank for all keywords for all days in the planning horizon, and a recommended bid price that will achieve that rank. And since spend is defined in terms of CTR and CPC, the spend allocations for each keyword and day may be computed as follows:

Spendₖₜ=CPCₖₜ*CTRₖₜ*IMPₖₜ

Spendₖₜ=wₖe^{z}^{ₖ}^{*x}^{ₖₜ}*IMPₖₜ

Prior to solving the budget allocation optimization problem, values may be assigned to the vectors and matrices identified in the problem formulation. These vectors may be identified by modeling CPC and CTR and matrix generation for problem specification.

### III.C. Modeling CPC and CTR

Much of the modeling notation in this section uses the notation of the R statistical computing language, which is documented at and available from www.r-project.org.

The mathematical optimization formulation of the budget allocation problem depends on values for expected CTR and CPC performance across a full range of average ranks. However, historic data may not provide a comprehensive view of performance at all average rank levels. Therefore, terms in the budget allocation optimization process may be based on mathematical inferences of likely CPC and CTR levels for any possible average rank. For purposes of modeling, CPC is assumed to have an exponential relationship with average rank.

CPCₖ=aₖe^{b}^{ₖ}^{*x}

Other models may be used as well, especially those that model the fall-off on click-through rate for impressions that fall “below the fold” of a single display screen, and a further fall off for ranks 11 and below that fall on a second or subsequent page. Note that this is a model of CPC and not Max CPC so it illustrates the relationship of the historic CPC data derived from the search engine to the average rank for the same timeframe. For modeling purposes it is assumed that the curve parameters aₖ and bₖ are specific to each individual keyword. The values of aₖ and bₖ are discovered by applying Ordinary Least Squares regression modeling to historic data from search engines (lm is the “fit linear model” function of the R language, http://stat.ethz.ch/R-manual/R-devel/library/stats/html/lm.html). In other cases, it may be desirable to apply other regression modeling techniques such as LAD (Least Absolute Deviation), and more generally any modeling technique which produces continuous estimates from discrete observed data will work. The fit is achieved by executing the R function lm as follows:

model=lm(log(CPCₖ), Rankₖ)

where
CPCₖ=c (Historic CPC data derived from search engine reporting for keyword k)
Rankₖ=c (Historic Rank data derived from the search engine reporting for keyword k) and setting

aₖ=exp(summary(model)$coefficient(1,1))

bₖ=summary(model)$coefficient(2,1)

Where data volumes, consistency or breadth are inadequate to accurately determine values for curve parameters at the individual keyword level, the campaign level curve may provide an acceptable default assumption. Extract the pValues for aₖ and bₖ

aₖPValue=summary(model)$coefficient(1,4)

bₖPValue=summary(model)$coefficient(2,4)

If (aₖPValue>0.05) or (bₖPValue>0.05) then

model=lm(log(CPC), Rank)

where
CPC=c (Historic CPC data derived from search engine reporting for all keywords)
Rank=c (Historic Rank data derived from the search engine reporting for all keywords) and

aₖ=exp(summary(model)$coefficient(1,1))

bₖ=summary(model)$coefficient(2,1)

CTR is assumed to have an exponential relationship with average rank.

CTRₖ=cₖe^{d}^{ₖ}^{*x}

For modeling purposes it is assumed that the curve parameters cₖ and dₖ are specific to each individual keyword. The values of cₖ and dₖ are discovered by applying Ordinary Least Squares regression modeling to historic data from search engines. (https://stat.ethz.ch/R-manual/R-devel/library/stats/html/lm.html). In other cases, it may be desirable to apply other regression modeling techniques such as LAD (Least Absolute Deviation), and more generally any modeling technique which produces continuous estimates from discrete observed data. The fit is achieved by executing the R function lm as follows:

model=lm(log(CPCₖ), Rankₖ)

where
CPCₖ=c (Historic CPC data derived from search engine reporting for keyword k)
Rankₖ=c (Historic Rank data derived from the search engine reporting for keyword k) and setting

cₖ=exp(summary(model)$coefficient(1,1))

dₖ=summary(model)$coefficient(2,1)

Where data volumes, consistency or breadth are inadequate to accurately determine values for curve parameters at the individual keyword level, the campaign level curve may be taken as a useful default assumption. Extract the pValues for cₖ and dₖ

cₖPValue=summary(model)$coefficient(1,4)

dₖPValue=summary(model)$coefficient(2,4)

If (cₖPValue>0.05) or (dₖPValue>0.05) then

model=lm(log(CPC), Rank)

where
CPC=c (Historic CPC data derived from search engine reporting for all keywords)
Rank=c (Historic Rank data derived from the search engine reporting for all keywords) and

cₖ=exp(summary(model)$coefficient(1,1))

dₖ=summary(model)$coefficient(2,1)

These two equations may provide models for computing CPC and CTR for all keywords for all average ranks.

III.C.1. Impression Forecast

A forecast of impressions for each keyword for each day of the planning horizon is developed from historic impressions reported by the search engine.

HistoricImpressionₖₜ=Impresssion values from search engine reporting

Set j as a sequence of days in the calendar year from 1 to either 365 or 366 depending on whether the planning horizon occurs in a leap year. Seasonality may be identified by Fourier analysis, spectral analysis, or any modeling technique that estimates periodic repetition of patterns in discrete observed data.

Aggregate impression counts to weekly counts:

WeeklyHistoricImpressionₖⱼ=Aggregated weekly impression values from search engine reporting aggregated weekly, where j is the day of year of the Wednesday of the week being aggregated.

For each week of the year set

wtⱼ=2π*j/(Number of days in the year)

where π represents the transcendental ratio of the circumference of a circle to its diameter.

Compute

C1ⱼ=cosine(wtⱼ)

S1ⱼ=sine(wtⱼ)

C2ⱼ=cosine(2*wtⱼ)

S2ⱼ=sine(2*wtⱼ)

C3ⱼ=cosine(3*wtⱼ)

S3ⱼ=sine(3*wtⱼ)

Use ordinary least squares for multiple independent variables to compute seasonality coefficients, which indicate seasonal variation in performance:

model=lm(WeeklyHistoricImpressionsₖⱼ˜C1ⱼ+S1ⱼ+C2ⱼ+S2ⱼ+C3ⱼ+S3ⱼ)

aₖ₀=summary(model)$coefficient(1,1)

aₖ₁=summary(model)$coefficient(2,1)

bₖ₁=summary(model)$coefficient(3,1)

aₖ₂=summary(model)$coefficient(4,1)

bₖ₂=summary(model)$coefficient(5,1)

aₖ₃=summary(model)$coefficient(6,1)

bₖ₃=summary(model)$coefficient(7,1)

If all coefficients have adequate PValue scores based on the following test

aₖₒPValue=summary(model)$coefficient(1,4)

If (aₖ₀PValue>0.05) or

(aₖ₁PValue>0.05) or

(bₖ₁PValue>0.05) or

(aₖ₂PValue>0.05) or

(bₖ₂PValue>0.05) or

(aₖ₃PValue>0.05) or

(bₖ₃PValue>0.05)

then

Use default seasonality

otherwise

Use keyword level seasonality

The historic seasonal estimate for each week is computed by assigning

SE_{jb}=a₀ₖ+a₁ₖ*C1ⱼ+b₁ₖ*S1ⱼ+a₂ₖ*C2ⱼ+b₂ₖ*S2ⱼ+a₃ₖ*C3ⱼ+b₃ₖ*S3ⱼ

for each j where j is the Julian date of a Wednesday in the year. The seasonality factor is then assigned for j representing a Wednesday as follows:

SFⱼₖ=SEⱼₖ/Average(SEⱼₖ)

The SFⱼₖ may provide a list of seasonal factors for each week of the year for each keyword, which may permit allocation budget to reflect the season of the year as it perturbs around the year-round average. A default seasonality may be computed based on brand terms. A keyword is said to be a brand keyword if it contains a reference to one or more brand words such as the name of the advertiser.
HistoricBrandImpressionsₖₜ=Sum of (Impresssion values from search engine reporting for all keywords containing brand words)
DefaultSFⱼ=The result of seasonality modeling for the sum of all brand keywords using the above process

All keywords that have not passed the default seasonality test may be assigned a default seasonality factor for each week j in the planning horizon:

SFⱼₖ=DefaultSFⱼ

A weekly trend factor may be computed using Ordinary Least Squares regression as follows:

model=lm(WeeklyHistoricImpressionsₖⱼ˜j)

trendₖ=summary(model)$coefficient(2,1)

A weekly default trend factor may be computed using Ordinary Least Squares regression as follows:

model=lm(HistoricBrandImpressionsⱼ˜j)

DefaultTrendₖ=summary(model)$coefficient(2,1)

In other cases, it may be desirable to apply other regression techniques to create the seasonality models such as LAD (Least Absolute Deviation), or any modeling technique that produces continuous estimates from discrete observed data. Day-of-week seasonality factors may be computed for each keyword. A sequential index may be assigned to each day of the week as follows:

m=1 if day of week is Sunday

m=7 if day of week is Saturday

Where a keyword has been assigned weekly seasonality at the keyword level, keyword-level day-of-week seasonality may be computed as follows:

DOWSFₖₘ=(Average(HistoricImpressionₖₜ) where t corresponds to DOW m)/(Average(HistoricImpressionₖₜ) where t is not limited to a specific day of week)

Where a keyword has not been assigned weekly seasonality at the keyword level, keyword-level day-of-week seasonality may be computed as follows:

DOWSFₖₘ=(Average(HistoricBrandImpressionsₖₜ) where t corresponds to DOW m)/(Average(HistoricBrandImpressionsₖₜ) where t is not limited to a specific day of week)

With these models we can now assign impression forecasts to all keywords for all days in the planning horizon as follows:

IMPₖₜ=DOWSFₖₘ*SFⱼₖ*j*Trendₖ*Average(Historic Impressions)

In other cases, it may be desirable to apply other forecasting techniques to create the Impression forecast such as ARIMA or Holt-Winters, and more generally any modeling technique which produces estimates for impressions that considers seasonality, trend and other leading indicators.

### III.D. Vector and Matrix Generation

Values may be assigned to all vectors and matrices in the problem formulation to permit use of a mathematical program solver for the budget allocation problem. Vector and matrix values may be assigned as follows:
Keyword: A list of keywords is derived from the bulksheet output of the Automated Account Restructure tool 200. Each of these keywords is assigned a unique sequence number associated with the subscript k in the problem formulation.
Planning Horizon: The number of days in the planning horizon is specified manually and each day in the planning horizon is assigned a sequence number represented by t in the mathematical notation.
CTR: for each keyword for each one tenth of a rank the value of CTR at that rank is assigned to the CTR vector as follows:

CTRₖₜ(xₖₜ)=cₖexp(dₖx)
The value of CTRₖₜ for may be set to a uniform constant for each value of t.
CPC: for each keyword for each one tenth of a rank the value of CPC at that rank is assigned to the CTR vector as follows:

CTRₖₜ(xₖₜ)=aₖexp(bₖx)
The value of CPVₖₜ for may be set to a uniform constant for each value of t by assumption.
Revenue per Click: The value of revenue per click is derived as the average revenue per click from historic values of revenue per click from search engine reporting. Revenue per click varies by day and keyword but is independent of rank.
RPCₖₜ=Average Revenue per click from search engine reporting. The value of RPCₖₜ for may be set to a uniform constant for each value of t by assumption.
Impressions: Impressions are derived from the impression forecast detailed above
Maximum Spend: Maximum spend limits are provided by the advertiser.

### III.E. Computation of Budget Allocation Values

At this stage almost all of the vectors and matrices in the problem formulation have been allocated values derived from search engine and related data. The only currently unallocated vectors are:

xₖₜ=Rank of keyword k on day t. This is our decision variable.

Sₖₜ(xₖₜ)=Spend for keyword k on day t.

The process of optimization uses mathematical programming solver software to assign values to the rank variable (xₖₜ) for each keyword for each day. The spend vector can then be derived directly from the rank variable using the formula

Spendₖₜ=wₖe^{z}^{ₖ}^{*x}^{ₖₜ}*IMPₖₜ

This provides recommended budget allocations for each keyword for each day in the planning horizon. Similarly, recommendations for Max CPC (maximum cost per click, the maximum bid for the keyword) can be derived from rank by the formula

Max CPCₖₜ=aₖexp(bₖxₖₜ)

Once the solver has returned the optimal values for rank for each keyword and day, there are two possible methods optimization methods to solve this problem:
Treat the values of the rank variable as integer values and optimize using integer programming software.
Treat the values of the rank variable as continuous and use convex optimization programming software.

III.E.1. Solution in Integer Programming

In order to solve the budget allocation problem as an integer programming problem we make the following additions to the model formulation:
‘i’ is a sequence number which represents an integer value corresponding to rank x. ‘i’ runs from 0 to 99 corresponding to x values incrementing by 1/10^{th} from 1 to 10. So we create two new vectors

pᵢₖₜ=vₖₜe^{d}^{ₖ}^{*(i+1)/10}^{ₖₜ}

qᵢₖₜ=wₖₜe^{z}^{ₖ}^{*(i+1)//10}^{ₖₜ}

And define a binary decision variable

δᵢₖₜ=(0,1)

with the constraint

Σᵢδᵢₖₜ≦1 for all k, t

To ensure that only a single rank is chosen for any given keyword on each day, the problem can now be expressed as a binary optimization problem as follows:

Maximize Σᵢₖₜ(pᵢₖₜ−qᵢₖₜ)*δᵢₖₜ

subject to:

Maximize Σᵢₖₜqᵢₖₜ*δᵢₖₜ*IMPₖₜ≦MaxSpend

Σᵢδᵢₖₜ≦1 for all k, t
δᵢₖₜ=1 where i is the selected rank for k and t, 0 otherwise

We use the R mathematical programming software library lpSolve (https://cran.r-project.org/web/packages/lpSolve/lpSolve.pdf) to discover the optimal values of the rank variable. We set up the problem in lpSolve as follows:

f.obj<-pᵢₖₜ−qᵢₖₜ

f.con<-matrix(c(δᵢₖₜ, nrow=NumDays*NumKeywords, byrow=TRUE), qᵢₖₜ)

f.dir<-c(“<=”, “<=”)

f.rhs<-c(rep(1,each=NumDays*NumKeywords), MaxSpend)

set.type(f, NumDays*NumKeywords,“binary”)

Then run the solver

lp(“max”, f.obj, f.con, f.dir, f.rhs)

And assign the results to the integer sequence for the variables

δᵢₖₜ,=get.variables(f)

In other cases, it may be desirable to apply other implementations of an integer programming solver such as Cplex, and more generally any mathematical optimization technique that produces optimal allocations for integer decision variables. We now need to back into the recommended rank and spend:

xₖₜ,=c(1:100)[(δᵢₖₜ]/10

With this x, the solution continues as described in §III.E.3. Integer programming

Integer programming techniques are described at https://en.wikipedia.org/wiki/Integer_programming, which is incorporated by reference.

III.E.2. Solution as a Convex Optimization

In order to solve the problem as a convex optimization problem, the Budget Allocation process may refine the solution from lpSolve using an R script for Frank-Wolfe piecewise linear approximation from (https://github.com/tatsiana/R_scripts/blob/master/Frank-Wolfe-Algorithm.R). In other cases, it may be desirable to apply other approximation techniques such as spline fitting, and more generally any curve approximation technique which produces continuous boundaries for a convex set. Define a initial solution

fbs<-xₖₜ

f<-vₖₜ*exp(dₖ*xₖₜ)−wₖₜ*exp(zₖ*xₖₜ)

dfₖ<-vₖₜ*dₖ*exp(dₖ*xₖₜ)−zₖ*wₖₜ*exp(zₖ*xₖₜ)

tol<−0.001

And execute the script

xₖₜ<-FW(fbs, f, df, tol, f.con, f.RHS,)

Convex optimization may be more desirable because it can generate a solution in real numbers, not only discrete integers. Even though any given search will give an integer rank to the ad, it may be desirable to target a non-integer average rank over the course of the day. For example, suppose there will be three searches today. Also suppose the auctions for each of these searches have the following costs

| Auction | Rank 1 | Rank 2 | Rank 3 |
|---|---|---|---|
| 1 | $1.10 | $0.70 | $0.50 |
| 2 | $0.90 | $0.80 | $0.70 |
| 3 | $1.00 | $0.75 | $0.60 |

If the optimization can only target an integer rank, then a target of rank 2 will require a bid of $0.80 to hit it each time. A target of integer rank 3 will require a bid of $0.70 to hit it each time. However, if the optimization software permits targeting a fractional rank of 2.3, the optimization may compute a bid price of $0.75 so that the search engine will place the ad at rank 2 twice and rank 3 only once. If the budget allocation module specifies a $0.75 spend on this keyword, then the convex optimization program will find the right answer, whereas an integer programming solution will come in with a $0.70 recommendation and miss opportunities that are still within budget.

Convex optimization techniques are described at https://en.wikipedia.org/wiki/Convex_optimization, which is incorporated by reference.

III.E.3. Completing the Solution

After computing xₖₜ by the method of §III.E.1 or §III.E.2, the recommended budget for each keyword on each day may be computed as

Spendₖₜ=wₖe^{z}^{ₖ}^{*x}^{ₖₜ}*IMPₖₜ

Recommended rank for each keyword on each day may be computed as

Max CPCₖₜ=aₖexp(bₖxₖₜ)

These recommendations are added to the bulksheet from Automated Account Restructure tool 200 for review by the media manager and upload to the search engine.

### III.F. The Auction Process

The Budget Allocation process of this section III computes a maximum cost-per-click value. Because some search engines use a “second price auction” protocol, the prices actually paid may be lower. A “first price auction” is the “classical” auction where the auction is won by the high bidder, and the winning bidder pays the bid price. A “second price auction” is an auction where the high bidder wins the auction, and pays either the price bid by the second-highest bidder, or a small price increment above the second-highest bid. Second price auctions tend to result in prices closer to the high bidder's true value, because the incentive to underbid that “true value” price is reduced. Second price auction works better for price discovery, and lead to more stable prices in repeat auctions, such as auctions for paid search advertising keywords.

### IV. Predictive Bidding for Keywords with Little Historical Data

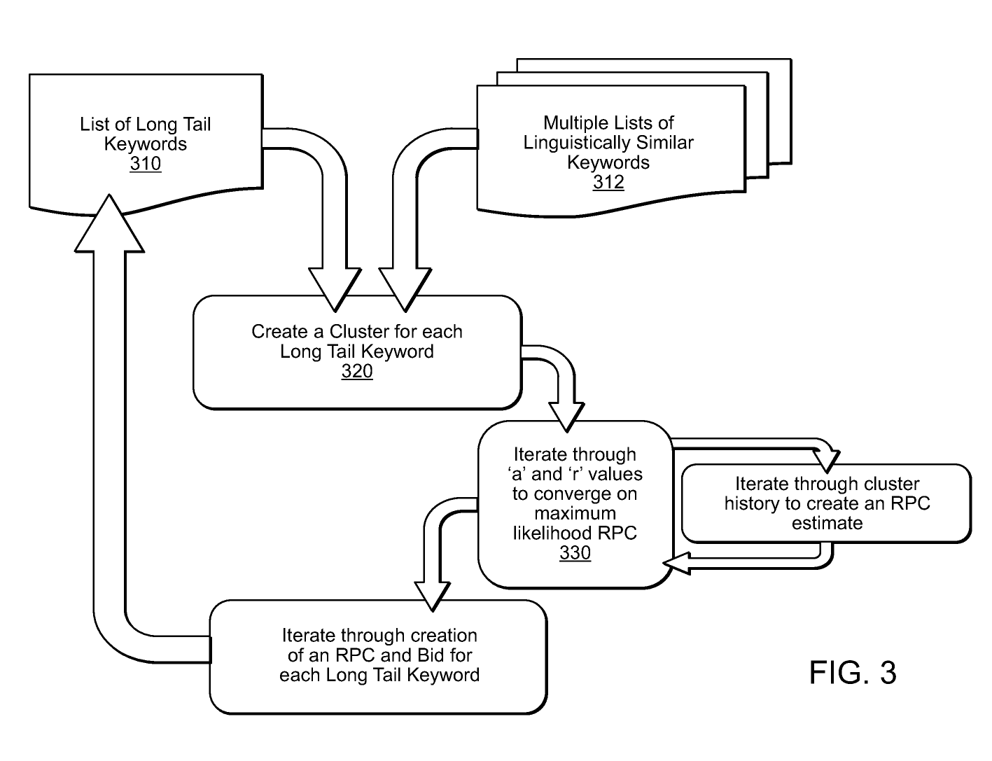

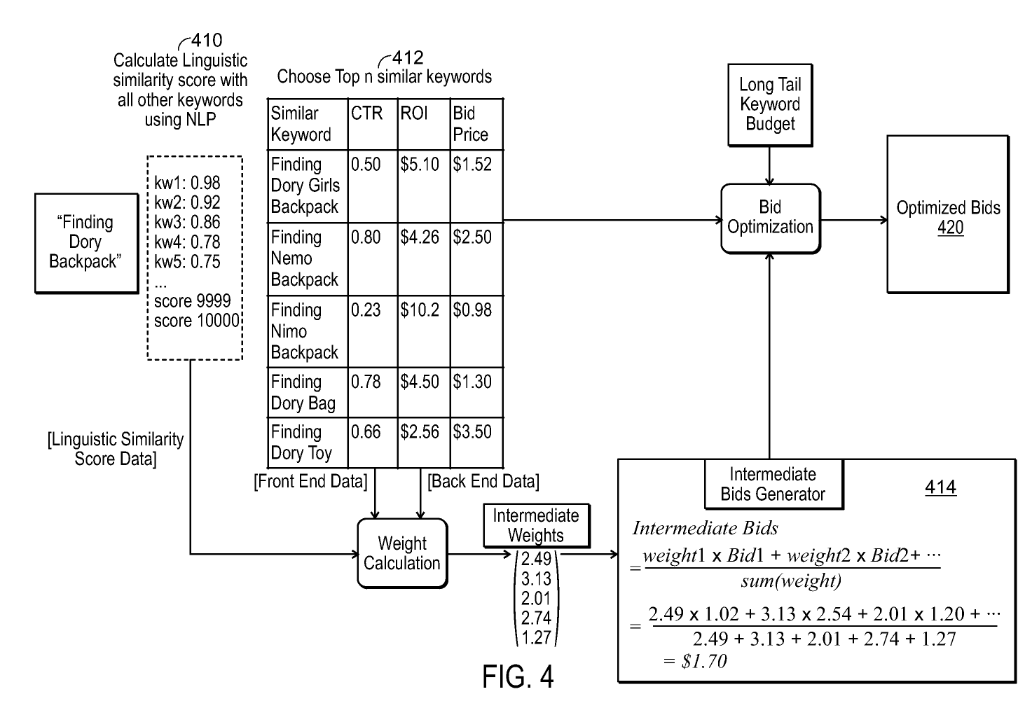

Referring to FIGS. 3 and 4, big online advertisers usually have millions of keywords in active search campaigns, spanning across a dozens of categories. Among these keywords, 90% are considered long tail because they drive less than 1 click per day. Yet aggregately they can contribute 20% click volumes. The challenge not only lays in setting up bids for these long tail keywords given lack of performance reference, but also in adjusting these bids constantly since often sales are affected by market trends and seasonality.

A number of keywords are highly specific, and therefore valuable, but of such low frequency use that it is difficult to price them. For example, ISBN numbers for books, SKU numbers for general merchandise, and the like, imply a very high level of interest on the part of a user, and high likelihood of conversion into a sale, but are extremely rarely used. Similarly, highly specific text keywords may indicate a similar level of interest. “Where is a good place to buy socks online?” and “window treatments for a Georgian house” are low frequency keywords. These are called “long tail keywords,” drawn from the far reaches of the distribution of keywords,

For such keywords, a Predictive Bidding algorithm may estimate a value. This algorithm may take into account linguistic similarity to other keywords, because linguistically similar keywords are likely to have similar performance. The linguistic similarity may indicate similar product offerings with similar sales prices, or similar propensity to convert because of shared cultural associations with the words used. For example, “Where is a good place to buy socks online?” has linguistic similarity with the keyword “socks” so it is reasonable to assume they have the same revenue per click. “Window treatments for a Georgian house” has linguistic similarity with “window,” “window treatments,” and “Georgian house” so these latter keywords can be used as proxies to price the long-tail keyword.

A Predictive Bidding module may use machine learning techniques, including statistical regression modeling and neural networks, to estimate linguistic similarity scores. Similarity scores resulting from the linguistic similarity evaluation may be organized into a matrix of similarity scores representing the similarity of each keyword that an advertiser may be interested in bidding on to all other keywords in the advertiser's interest set.

Expected Return on Ad Spend (ROAS) of each keyword may be estimated from historical performance data, based on observed conversion rate and value per click. Bids may be adjusted from previous bid recommendations through a Bayesian updating processes that balances the information from recent ROAS performance observations and the information from historic ROAS performance based on the observed variability in ROAS performance over time. Bids may be further adjusted for desktop vs. mobile devices to account for differential search behavior and advertiser ROAS thresholds between web based search on personal computers and search on mobile devices. These adjustments may be made as a result of analysis of historical performance to develop a mobile multiplier which is applied to the bids for mobile devices. Additionally, embodiments may adjust bids to account for value creation resulting from paid search relative to offline environments such as physical storefronts or call centers. These adjustments may be made as a result of analysis of historical performance and multivariate testing to discover variations in offline metrics, including but not limited to sales or phone call volume, relative to variations in advertising metrics, including but not limited to search impression volume, click volume and search

### IV.A. Inputs, Outputs, and Overview of Process

Referring to FIG. 3, a predictive bidding process may take as inputs
A list 310 of long-tail keywords—because of their low click rates, their performance is not well-enough understood to permit reliable bidding
Lists 312 of other keywords whose performance is known, and the known click-through rate and revenue-per-click of these known keywords

The output of the Predictive Bidding process is a set of adjusted bids for the long-tail keywords, perhaps adjusted from the bids set by the Budget Allocation process of section III, above.

The process may proceed along the following steps:
1. Take as input, a list 310 of long tail keywords which do not have sufficient performance history to compute an accurate bid. The definition of a long tail keyword is generally less than one click per day.
2. Take as input, for each long tail keyword, a list of linguistically similar keywords 312 that do have sufficient history to compute an accurate bid:
   a Sufficient history is taken to mean greater than one click per day
   b Linguistic similarity is taken to mean a General relatedness score of 10% or greater—for example, this relatedness may be computed using the techniques of section II.C.2.
3. For each long tail keyword create a cluster 320 of all linguistically similar keywords. Keyword clusters may be specified by hand, or may be built up by computer, for example, using the algorithms discussed in section II.C.
4. Find the maximum value of the log-likelihood equation from Kalman filter modeling (step 330)—by maximizing the value of this equation, the known information about revenue per click and cost per click from past measurements of imperfectly-correlated phenomena is combined as effectively as it can be, and total error in the forecast is at a minimum, so that the predicted RPC is in fact the true unobserved RPC:

$$- \frac{T - ln ( 2 π )}{2} - \frac{1}{2} {\sum }_{t = 1}^{T} ln ( Var ( {C}_{tPredicted} ) ) - \frac{1}{2} {\sum }_{t = 1}^{T} \frac{{( {C}_{t} - E [ {C}_{tPredicted} ] )}^{2}}{Var ( {C}_{tPredicted} )}$$

a For each time interval in the cluster's history, execute the following steps 4(a)(i) to 4(a)(iii), to
   i For each cluster, compute the RPC (Revenue Per Click) or other success metric, as a weighted average of the keywords in the cluster.
   ii At each time interval assign the RPC of the cluster as the estimate of the RPC for the long tail keyword
   iii Revise the previous long tail keyword RPC to take into account the new estimate of the RPC based on the RPC of the cluster
b When the iteration over time intervals (Step 4.a) is complete, an RPC estimate for the long tail keyword is computed, based on the equation:

$${C}_{t} = \frac{{\sum }_{j = 1}^{n} {RPC}_{j} * {RelatednessCoefficient}_{i , j}}{{\sum }_{j = 1}^{n} {RelatednessCoefficient}_{i , j}}$$

c Revise the values of the parameter assumptions for the model of Step 4.a to maximize the log-likelihood equation. For example, the value of model parameters may be varied to reduce forecast variance, thereby producing a more accurate model.
d Repeat step 4 for each long tail keyword until changes in the model parameters no longer result in a significant change in RPC (e.g., less than $0.001 change)
5. Convert the RPC estimate into a bid estimate by multiplying the RPC by the reciprocal of the target ROAS.
   a For example, if the target ROAS is $5, then the target is to receive $5 in revenue, profits, or other proceeds, for every $1 in spend
   b If the RPC is $15, then the advertiser may be willing to spend $3 per click i.e.
      i $15/$3=RPC/ROAS Target

Many models in economics and finance depend on data that are not observable. These unobserved data are usually in a context in which it is desirable for a model to predict future events. The Kalman Filter (https://en.wikipedia.org/wiki/Kalman_filter) has been used to estimate an unobservable source of jumps in stock returns, unobservable noise in equity index levels, unobservable parameters and state variables in commodity futures prices, unobservable inflation expectations, unobservable stock betas, and unobservable hedge ratios across interest rate contracts. Long tail keywords are keywords that have low click volume, e.g. historically average less than one click per day. Because of this sparsity, metrics specific to these keywords, such as RPC (Revenue Per Click), may be regarded as unobservable.

The predictive bidding mathematical model is a modified Kalman Filter, for modeling long tail keywords' performance (e.g. RPC) as the unobserved variable. It uses natural language processing to link a keyword with other keywords which are linguistically similar and therefore represent similar products and buying intentions. It then uses the performance of all of the linked keywords to feed into the Kalman Filter as an observable variable in order to predict future performance of long tail keyword. Finally, the long tail bid is computed by combining the observed and predicted performance while taking into account of the key objective (such as ROAS) of the category this keyword is in.

### IV.B. Modified Kalman Filter

Kalman filtering, also known as linear quadratic estimation (LQE) is an algorithm that uses a series of measurements observed over time. Two basic building blocks of the Kalman Filter are the measurement (observation) equation and the transition (state) equation. Let
Wₜ: Long tail keyword's value at time t based on Revenue per Click (Unobserved)
Cₜ: The cluster of keywords' value at time t based on Revenue per Click (Observed)

The measurement equation relates the unobserved variable (Wₜ) to an observable variable (Cₜ).

Cₜ=mₜ*Wₜ+bₜ+εₜ (1)

Here mₜ is the observation model which maps the true state space into observed space and εₜ is the observation noise. For simplification assume:

mₜ=m(constant)

bₜ=0

For the error term εₜ, the errors are assumed to be symmetric, so the expected value is assumed to be zero:

E[εₜ]=0

Var(εₜ)=rₜ

Then equation (1) becomes:

Cₜ=m*Wₜ+εₜ (2)

The transition equation allows the unobserved variable to change through time.

Wₜ₊₁=aₜ*Wₜ+gₜ+θₜ (3)

Here aₜ is the state transition model which is applied to the previous state Wₜ. θₜ is the process noise. For simplification assume:

aₜ=a(constant)

gₜ=0

Also for the error term θₜ:

E[θₜ]=0

Var(θₜ)=qₜ

Then equation (3) becomes:

Wₜ₊₁=a*Wₜ+θₜ (4)

The Modified Kalman Filter algorithm is executed sequentially for each long tail keyword to find an estimate for the unobserved RPC. The output of the algorithm is the assignment of a bid (i.e. Max CPC) to the keyword based on the RPC.

Prior to executing the Predictive Bidding algorithm, a set of linguistically similar keywords, each of which already has a Revenue Per Click history, is associated with the long tail keyword. The RPC history is a series of RPC observations over time. So each of the linguistically similar keywords has a series of RPC observations for the time period under review. The minimum amount of history is 12 weeks, but in general 52 weeks is preferred. The time period for RPC readings is generally weekly. For a long tail keyword P, we include a keyword R from the linguistically similar keywords in the long tail keyword's representative cluster if the 360i Relatedness Coefficient meets a minimum threshold, such as 10%. We compute the RPC for the cluster as follows:

$${C}_{t} = \frac{{\sum }_{j = 1}^{n} {RPC}_{j} * {RelatednessCoefficient}_{i , j}}{{\sum }_{j = 1}^{n} {RelatednessCoefficient}_{i , j}}$$

where n is the number of keywords in the cluster. Using the relationships between Wₜ, the long tail keyword RPC and Cₜ, the cluster RPC, described above we can construct an assumed RPC history. We then iteratively maximize the log-likelihood function:

$$- \frac{T - ln ( 2 π )}{2} - \frac{1}{2} {\sum }_{t = 1}^{T} ln ( Var ( {C}_{tPredicted} ) ) - \frac{1}{2} {\sum }_{t = 1}^{T} \frac{{( {C}_{t} - E [ {C}_{tPredicted} ] )}^{2}}{Var ( {C}_{tPredicted} )}$$

where:

E[C_{tPredicted}]=E[W_{tAdjustedPrediction}]

E[W_{tAdjustedPrediction}]=E[W_{tPredicted}]+kₜ*(Cₜ−E[C_{tPredicted}])

E[W_{tPredicted}]=a*Wₜ₋₁

C_{tError}=Cₜ−C_{tPredicted}

The final step is to compute a recommended bid for the long tail keyword by multiplying the reciprocal of the target ROAS with estimated RPC.

Recommended Bid=RPC/ROAS_{target}

### IV.C. Derivation in Support of the Maximum Likelihood Equation

This derivation is include to illustrate how the Maximum Likelihood equation depend on “a” and “r”. We start with an initial value for “W₀” inserted into equation (4) above. This value is set to historical average Revenue per Click (RPC) of the long tail keyword if available. If the value is not available, cluster's historical average RPC is set as the initial value. It should be noted that:

E[W₀]=μ₀

Var(W₀)=σ₀

Note that “εₜ”, “θₜ”, and “W₀” are uncorrelated and are uncorrelated relative to lagged variables.

W_{1Predicted}=a*W₀+θ₀ (5)

where:

W_{1Predicted}: Predicted RPC value for long tail keyword at time t=1

For constructing the algorithm “W_{1Predicted}” inserted into equation (2) (2) Cₜ=m*Wₜ+εₜ then equation becomes:

C_{1Predicted}=m*W_{1Predicted}+ε₁ (6)

C_{1Predicted}=m*[a*W₀+θ₀]+ε₁ (6)

where:

C_{1Predicted}: Predicted RPC value for keyword cluster at time t=1

Since Cₜ is observable, when C₁ RPC value for cluster occurs, the error C_{1Error} can be computed by following equation:

C_{1Error}=C₁−C_{1Predicted} (7)

The error now can be incorporated into the prediction for “W₁”. In order to distinguish predicted value of “W₁” from prediction adjustment, determine:
“W_{1AdjustedPrediction}: Adjusted prediction of long tail keyword given observed error of keyword cluster prediction

The equation for adjusted prediction can be represented with including Kalman gain variable “k₁” in relation to error term “C_{1Error}”:

W_{1AdjustedPrediction}=W_{1Predicted}+k₁*C_{1Error}

W_{1AdjustedPrediction}=W_{1Predicted}+k₁*[C₁−C_{1Predicted}]from (7) (8)

W_{1AdjustedPrediction}=W_{1Predicted}+k₁*[C₁−m*W_{1Predicted}−ε₁] from (6) (8)

By rearranging terms:

W_{1AdjustedPrediction}=W_{1Predicted}*[1−m*k₁]+k₁*C₁−k₁*ε₁ (8)

The solution for Kalman gain variable “k₁” is determined by taking partial derivative of “W_{1AdjustedPrediction}” with respect to “k₁” and setting it to zero.

For ease of exposition let:

$$\begin{matrix} Var ( {W}_{1 Predicted} ) = {p}_{1} \\ {W}_{1 AdjustedPrediction} = {W}_{1 Predicted} [ 1 - m * {k}_{1} ] + {k}_{1} * {C}_{1} - {k}_{1} * {ɛ}_{1} from \\ And & ( 8 ) \\ Var ( {W}_{1 AdjustedPrediction} ) = Var ( {W}_{1 Predicted} * [ 1 - m * {k}_{1} ] + {k}_{1} * {C}_{1} - {k}_{1} * {ɛ}_{1} ) & ( 9 ) \\ Var ( {W}_{1 AdjustedPrediction} ) = Var ( {W}_{1 Predicted} ) * {[ 1 - m * {k}_{1} ]}^{2} + Var ( {C}_{1} ) * {k}_{1}^{2} + Var ( {ɛ}_{1} ) * {k}_{1}^{2} & ( 9 )\end{matrix}$$

Please note that all covariance terms are neglected since “εₜ”, “θₜ”, and “Wₜ” are uncorrelated.

Also recall that:

Var(ε₁)=r₁

Var(C₁)=0 (Observed value of keyword cluster at time t=1)

So equation can be simplified as:

Var(W_{1AdjustedPrediction})=p₁*[1−m*k₁]²+r₁*k₁² (9)

Setting partial derivative with respect to “k₁” to zero leads to:

$$\frac{\partial Var ( {W}_{1 AdjustedPrediction} )}{\partial {k}_{1}} = - 2 * m * {p}_{1} * [ 1 - m * {k}_{1} ] + 2 * {r}_{1} * {k}_{1} = 0 \qquad ( 10 )$$

Solving for “k₁”:

$${k}_{1} = \frac{m * {p}_{1}}{( {m}^{2} * {p}_{1} + {r}_{1} )} \qquad ( 11 )$$

Equation (11) has an interpretation as it's equivalent to “β−coefficient” from linear regression with “C_{1Predicted}” as the independent variable and “W_{1Predicted}” as the dependent variable. In order to see this relation recall:

C_{1Predicted}=m*W_{1Predicted}+ε₁ (6)

Var(W_{1Predicted})=p₁

Var(ε₁)=r₁

So we can restate:

Var(C_{1Predicted})=Var(m*W_{1Predicted}+ε₁) (12)

Var(C_{1Predicted})=m²*Var(W_{1Predicted})+Var(ε₁) (12)

Var(C_{1Predicted})=m²*p₁+r₁ (12)

Also:

$$\begin{matrix}Cov ( {W}_{1 Predicted} , {C}_{1 Predicted} ) = Cov ( {W}_{1 Predicted} , m * {W}_{1 Predicted} + {ɛ}_{1} ) & ( 13 ) \\ Cov ( {W}_{1 Predicted} , {C}_{1 Predicted} ) = m * Cov ( {W}_{1 Predicted} , {W}_{1 Predicted} ) + m * Cov ( {W}_{1 Predicted} , {ɛ}_{1} ) & ( 13 )\end{matrix}$$

Second term is zero as Cov(W_{1Predicted}, ε₁)=0.

Cov(W_{1Predicted}, C_{1Predicted})=m*Cov(W_{1Predicted}, W_{1Predicted}) (13)

Cov(W_{1Predicted}, C_{1Predicted})=m*Var(W_{1Predicted}) (13)

Cov(W_{1Predicted}, C_{1Predicted})=m*p₁ (13)

By (11), (12) & (13) we have:

$$∴ {k}_{1} = \frac{m * {p}_{1}}{( {m}^{2} * {p}_{1} + {r}_{1} )} = \frac{Cov ( {W}_{1 Predicted} , {C}_{1 Predicted} )}{Var ( {C}_{1 Predicted} )}$$

“k₁” Kalman gain is set to reduce the variance in the adjusted predicted value for “W₁” (i.e., (W_{1AdjustedPrediction}).

If equivalent values at time t=2 is required, the step is to use “W_{1AdjustedPrediction}” in the transition equation for “Wₜ”.

W_{2Predicted}=a*W_{1AdjustedPrediction}+θ₁
W_{2Predicted}: Predicted RPC value for long tail keyword at time t=2

For Predictive Bidding our focus is to determine W_{1AdjustedPrediction}. So algorithm predicts only one-step-ahead at a time, and to focus on “W_{1AdjustedPrediction}” over “W_{1Predicted}”.

Recall:

Var(W_{1Predicted})=p₁

Substituting equation (11) into equation (9), Var(W_{1AdjustedPrediction}) can be determined as:

$$\begin{matrix} {k}_{1} = \frac{m * {p}_{1}}{( {m}^{2} * {p}_{1} + {r}_{1} )} & ( 11 ) \\ Var ( {W}_{1 AdjustedPrediction} ) = {p}_{1} * {[ 1 - m * {k}_{1} ]}^{2} + {r}_{1} * {k}_{1}^{2} & ( 9 ) \\ Var ( {W}_{1 AdjustedPrediction} ) = {p}_{1} * {[ 1 - m * \frac{m * {p}_{1}}{( {m}^{2} * {p}_{1} + {r}_{1} )} ]}^{2} + {r}_{1} * {k}_{1}^{2} & ( 12 ) \\ Var ( {W}_{1 AdjustedPrediction} ) = {p}_{1} * {[ 1 - \frac{{m}^{2} * {p}_{1}}{( {m}^{2} * {p}_{1} + {r}_{1} )} ]}^{2} + {r}_{1} * {k}_{1}^{2} & ( 12 ) \\ Var ( {W}_{1 AdjustedPrediction} ) = {p}_{1} * {[ 1 - \frac{1}{( 1 + \frac{{r}_{1}}{{m}^{2} * {p}_{1}} )} ]}^{2} + {r}_{1} * {k}_{1}^{2} & ( 12 )\end{matrix}$$

Notice that the term scaling variance of

$$“ {W}_{1 Predicted} “ {[ 1 - \frac{1}{( 1 + \frac{{r}_{1}}{{m}^{2} * {p}_{1}} )} ]}^{2} ,$$

is less than one and it's squared further reducing the variance attributed to estimating “W₁”.

### IV.D. Mean and Variance of Kalman Predictions

$$\begin{matrix} E [ {W}_{tAdjustedPrediction} ] = E [ {W}_{tPredicted} + {k}_{t} * {C}_{tError} ] & ( 13 ) \\ E [ {W}_{tAdjustedPrediction} ] = E [ {W}_{tPredicted} ] + {k}_{t} * ( {C}_{t} - E [ {C}_{tPredicted} ] ) & ( 13 ) \\ Var ( {W}_{tAdjustedPrediction} ) = {p}_{t} * {[ 1 - \frac{1}{( 1 + \frac{{r}_{t}}{{m}^{2} * {p}_{t}} )} ]}^{2} + {r}_{t} * {k}_{t}^{2} & ( 14 ) \\ E [ {C}_{tPredicted} ] = E [ m * {W}_{tAdjustedPrediction} + {ɛ}_{t} ] = m * E [ {W}_{tAdjustedPrediction} ] & ( 15 ) \\ Var ( {C}_{tPredicted} ) = Var ( {W}_{tAdjustedPrediction} ) * {m}^{2} + {r}_{t} & ( 16 )\end{matrix}$$

### IV.E. Expectation Maximization with Maximum Likelihood Estimation

Observable variable of cluster of keywords RPC has a time series of values and distribution based on its predicted value “C_{tPredicted}”, with mean and variance determined in equations (15) & (16). Also Kalman Filter provides estimated value of long tail keywords RPC “W_{tAdjustedPrediction}” as a time series with mean and variance determined in equations (13) & (14). What Kalman Filter cannot determine are unknown parameters in measurement and transition equations. Namely; “εₜ”, “a” and “θₜ”.

If serially independent and normally distributed “C_{tPredicted}” is assumed with mean and variance defined by equations (15) & (16), following joint likelihood function can be determined:

$${\prod }_{t = 1}^{t = T} \{ {[ \frac{1}{\sqrt{2 π * Var ( {C}_{tPredicted} )}} ]}^{T} * {e}^{- \frac{{\sum }_{t = 1}^{T} {( {C}_{t} - E [ {C}_{tPredicted} ] )}^{2}}{2 * Var ( {C}_{tPredicted} )}} \} \qquad ( 17 )$$

For simplifying calculations it's common to use log-likelihood function of the form:

$$- \frac{T - ln ( 2 π )}{2} - \frac{1}{2} {\sum }_{t = 1}^{T} ln ( Var ( {C}_{tPredicted} ) ) - \frac{1}{2} {\sum }_{t = 1}^{T} \frac{{( {C}_{t} - E [ {C}_{tPredicted} ] )}^{2}}{Var ( {C}_{tPredicted} )} \qquad ( 18 )$$

Unknown parameters in measurement and transition equations (i.e., “εₜ”, “a” and “θₜ”), can be calculated by taking partial derivate of log-likelihood function with respect to each unknown parameter and setting to zero. Further simplifying assumption of constant variation of error terms may be employed:

Var(εₜ)=rₜ=r(constant)

Var(θₜ)=qₜ=q(constant)

After a set of parameters estimated (maximum likelihood estimates MLEs), the Kalman Filter algorithm is applied again which will produce new time series of “C_{tPredicted}” & “W_{tAdjustedPrediction}” with associated distributions. The likelihood estimation then performed again producing new MLEs which will again enter into Kalman Filter. This iterative process will continue until the value of equation (18) does not improve significantly.

### IV.F. Weighted Average of Bid Prices for Linguistically Similar Keywords

Referring to FIG. 4, a second approach for predictive bidding for long tail keywords begins by using natural language processing to compute a linguistic similarity measure (step 410) to identify other keywords that are linguistically similar and therefore represent similar products and buying intentions. Depending on the number of long-tail keywords, the algorithm may link the top 5 or 10 keywords (step 412). Factors for linguistic similarity, front end performance, and back end performance of keywords may be computed together to compute weights that each linked keyword will have on the bid of the keyword in question. Matrix multiplication of these weights with existing bids of keywords gives us the intermediate bid (414) for the keyword in question.

The following table shows one possible computation for weights for the linked keywords:

| | | Front End | | Backend | | |
|---|---|---|---|---|---|---|
| Linguistic | | Performance | | Performance | | |
| similarity score | | (CTR) | | (ROI) | | Final Weight |
| 0.98 | × | 0.50 | × | $5.10 | = | 2.49 |
| 0.92 | | 0.80 | | $4.26 | | 3.13 |
| 0.86 | | 0.23 | | $10.20 | | 2.01 |
| 0.78 | | 0.70 | | $4.50 | | 2.74 |
| 0.75 | | 0.66 | | $2.56 | | 1.27 |

Linguistic similarity can be computed as Levenshtein distance, or another linguistic similarity algorithm, such as those enumerated in section II.C.2.

CTR, click-through rate, may be computed as clicks received per number of impressions delivered.

Backend performance may be computed as return on investment (ROI), which may be computed as revenue per media cost. Revenue may be either top-line revenue, net margin, margin before or after fixed cost. Other measures of backend performance may be used, such as revenue per click (RPC), cost per revenue (CPR), or cost per acquisition of a sale or new customer (CPA).

The numbers in the weight column may be combined, for example by computing a mean. Then some appropriate multiplier may be applied—for example, it may be profitable to bid up to 80 cents for each incremental dollar of fully-netted profit.

Once bids for all long-tail keywords are calculated, an optimization step adjusts the bids to make sure that bids are optimized for the budget allocated to each of the batches of long-tail keywords.

In the optimization step 420, long-tail keywords are grouped into three groups, namely, Relatively Poor Performers, Relatively Neutral Performers, and Relatively High Performers using a metric called Performance Score. Performance score is defined as

$$performance score = net ROI \times CTR \times rank$$

$$net ROI = \frac{revenue - Cost}{Cost}$$

The idea behind grouping long-tail keywords is when budget exceeds Spend (spend=ΣBids*Clicks_{expected}), then budget of the Relatively Poor Performers can be reduced, and reallocated to maintain or increase budget of the Relatively High Performers. The reallocation of the budget is determined using following rules.
For Relatively Poor performing keywords (negative performance score), lower bids by 50% and calculate saved budgets.
   new bids=0.5×old bids
   budgets=0.5×sum(cost)
   sum(cost): cost for all Relatively Poor performance score keywords
For Relatively Neutral performing keywords (performance score=0), keep bids unchanged.
For Relatively High performing keywords (positive score), relocate saved budget from the Relatively Poor performing keywords among all the Relatively High performing keywords. One possible computation might be.
   Top 50% of Relative High Performing keywords may be increased by some value, or example a multiplier applied uniformly:

$$m = \sqrt[2]{\frac{2 \times Budgets}{3 \times Sum ( Cost )}}$$

$$new bids = old bids \times m$$

$$sum ( cost ) \text{:} cost for all top 50 \% keywords$$

Bottom 50% of Relative High Performing keywords may be multiplied by a lower value, for example:

$$n = \sqrt[2]{\frac{1 \times Budgets}{3 \times Sum ( Cost )}}$$

$$new bids = old bids \times n$$

$$sum ( cost ) \text{:} cost for all last 50 \% keywords$$

### V. Health Score

### V.A. Overview

In keyword advertising auctions, for example a Google adwords auction, the auction (and thus the sale of space to an advertiser/client) is not always awarded to the highest bidder. Because Google charges advertisers by click-through rather than by raw impressions, the Google auction agent awards advertising space partially on the bid amount, but also on the basis of a fudge factor called the “quality score,” which is Google's evaluation of the likelihood that a given impression will get a clickthrough (and thus payment to Google). Factors that influence the quality score include wording of the creative (the ad copy to be presented on the search page as a sponsored link), the relevance of the Landing Page (LP) to the inferred intent of the user, historical Click-through Rate (CTR) of this keyword for this advertiser, and other factors that the search engine sponsor considers relevant. The dimensionality of the quality score is:

QualityScore_{keyword} [symbol] f(Landing Page_{keyword}, Click-Thru-Rate_{keyword}, Creative_{keyword})

Some components of the Google quality score are within the control of the advertiser/client, for example, the quality of the landing page and creative. On the other hand, some portions of the Google quality score are largely out of the advertiser/client's control, such as the click-through rate, which is partially controllable (for example, by selecting broad vs. exact match), and partially uncontrollable, for example, the click-through rate is highly dependent on other ads that come up on a given page of search results, and the relative rank ordering of ads presented on the page.

The Google quality score is available to the specific advertiser/client to understand the advertiser/client's own keywords, but in general, quality score for others' pages and keywords is not available to the public. The advertiser may see the quality score of his/her own keywords (typically aggregated on a daily basis, with a one-day delay in the data), but not quality scores of others. The quality score changes nearly continuously, as the page changes, as click-through rates change, as Google makes small changes in the computation algorithm, and the like. The quality score reflects an assessment of factors such as how well the ad is written, how relevant the landing page is to the keyword, how fast the website loads, historical cost per click and click-through rate numbers, and similar factors that relate to user experience and ad performance. An ad with a good quality score may rank higher on a paid search list than a page with a higher bid price.

A Health Score feature (500 of FIG. 1) may be a decision support system that supports media managers with work flow management. The Health Score feature may identify elements of a paid search account that require attention. The Health Score feature may implement a proprietary scoring mechanism that monitors the general health of a paid search account on any level of granularity. It may evaluate the relevancy and the quality of the ad copy and the landing page to the searched keywords. In addition, the Health Score may provide a hierarchical view of all paid search accounts. Current performance and historical trends are presented together with the scores. The ability to export Health Reports provides media teams with the list of actionable suggestions for the improvements in the account.

The goal of the Health Score is to evaluate the performance of the most important keywords in an account. A Health Score attempts to track the search engine's quality score, to assist advertisers in framing their creatives, and in identifying factors in an ad that can raise or lower the search engine's quality score, and thus the page rank among paid search ads. The Health Score feature may include one or more of several broad features—
An evaluation of an advertiser/client's keyword combinations in context of the creatives at the respective landing pages, to attempt to predict the search engine's quality score
Diagnostic information about the creative to advise the advertiser how to elevate the search engine's quality score, so that the ad will rank higher in paid search results
A revenue loss or gain prediction to assist advertisers in reframing their ads to maximize profitability
Internal monitoring of the Health Score against the search engine's quality score to improve correlation between the Health score and the search engine's quality score, given the unknown internal nature of the latter

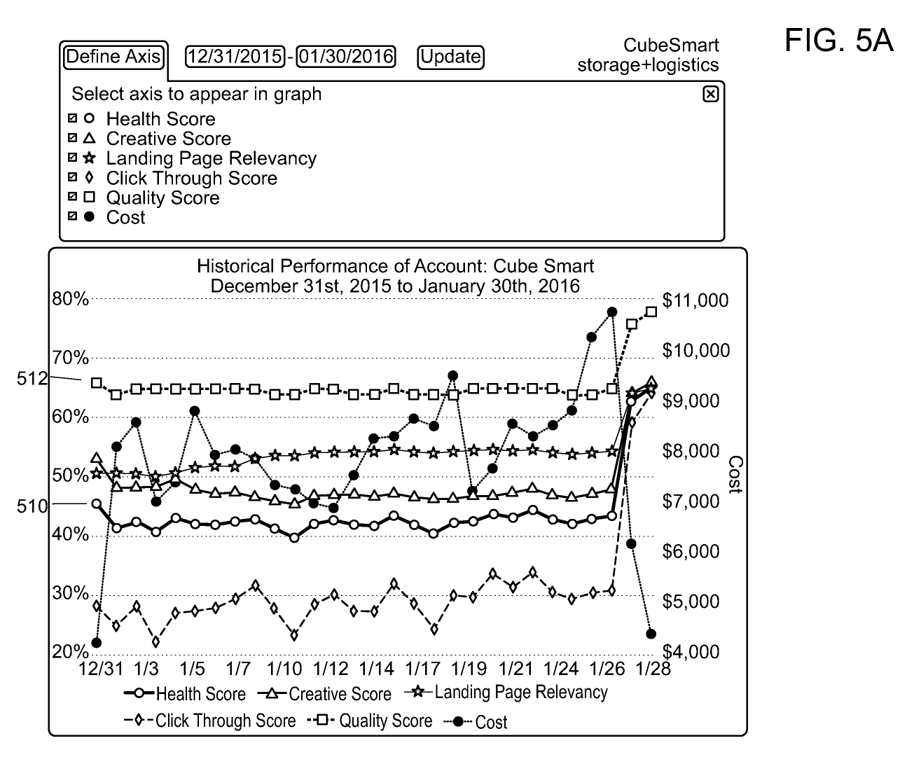

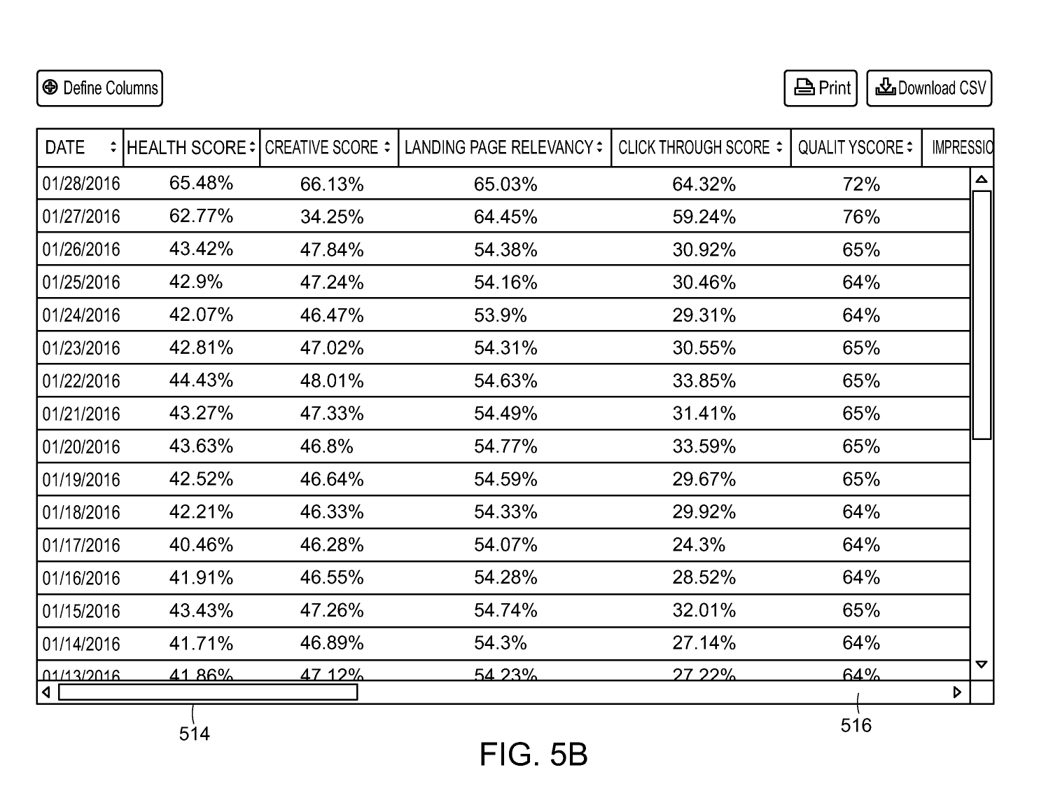

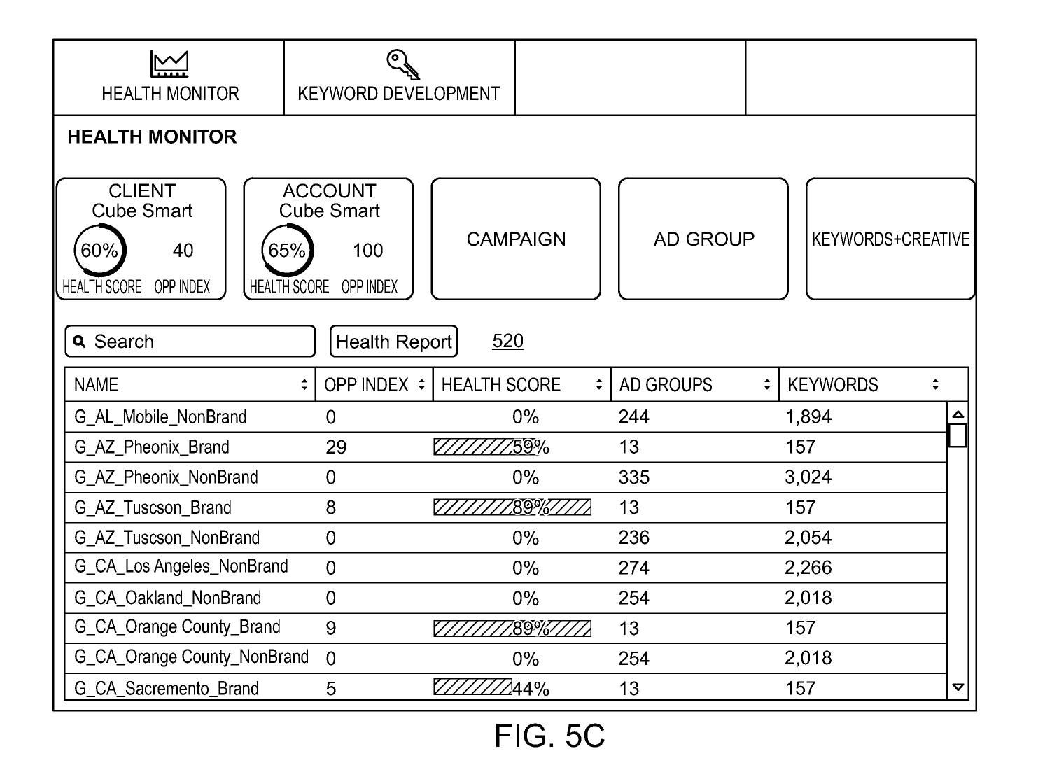

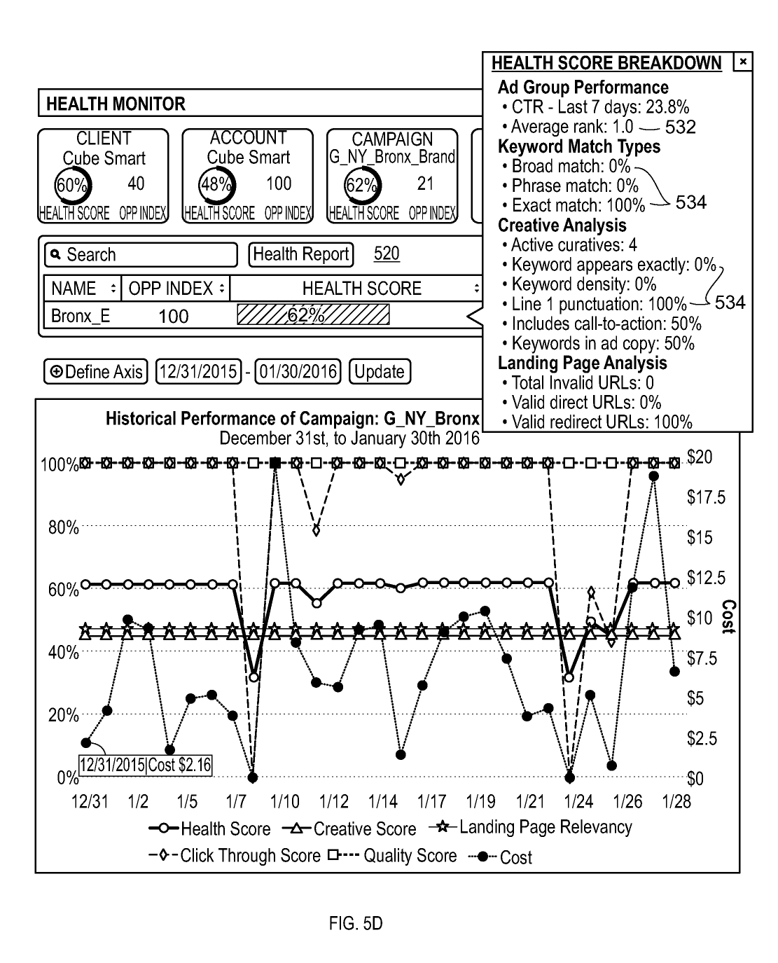

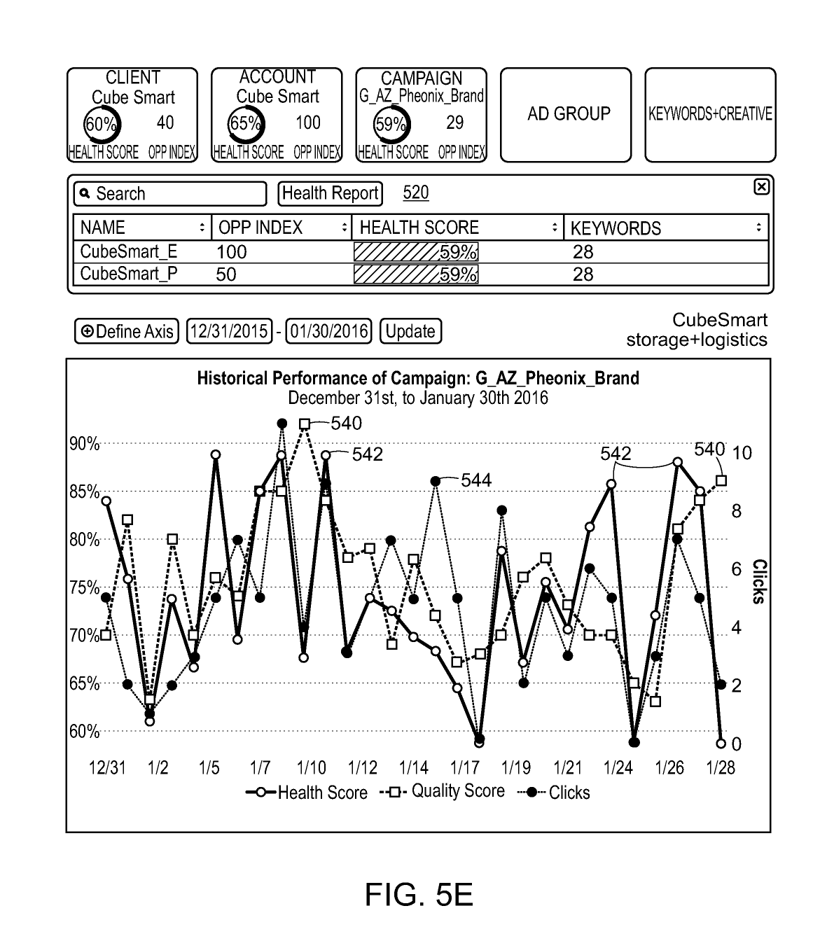

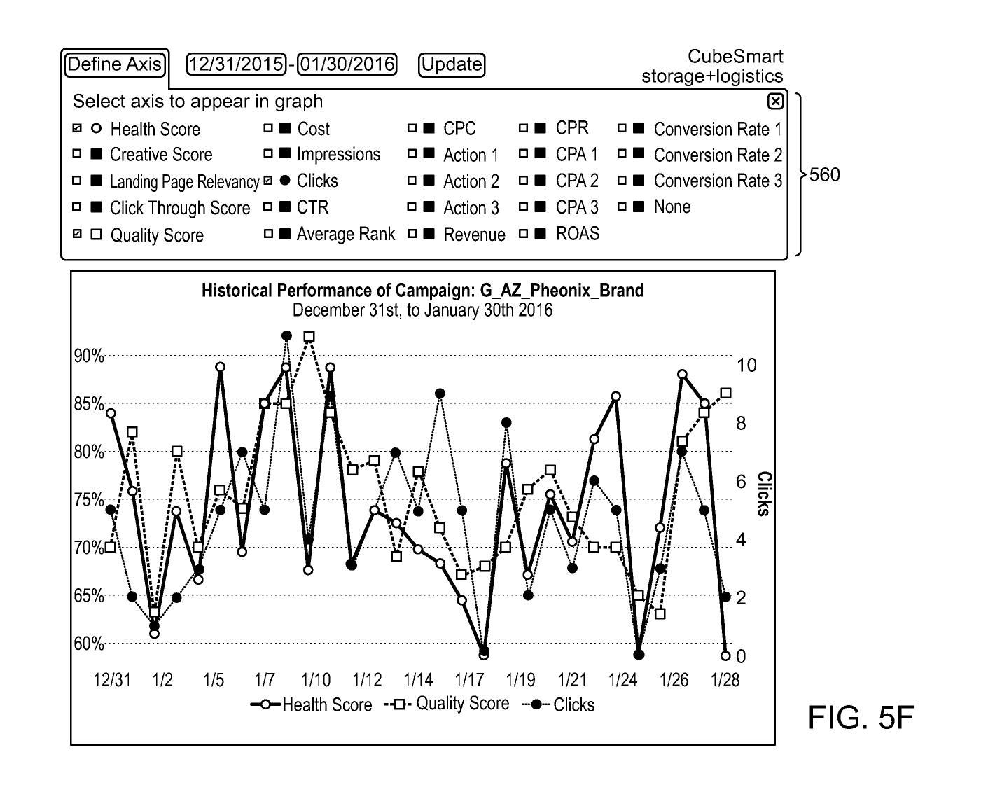

Referring to FIG. 5a, a screen shot shows that the Health Score (curve 510) correlates well to the Google Quality Score (curve 512) for an advertiser's own page. Though not numerically equal, the variations track each other well.

Referring to FIG. 5b, the same data appear in tabular form. Column 514 is the Health Score, and column 516 is the search engine's quality score.

Health Score 510, 514 may be used by an advertising or advertising manager to tune advertising, for example to get ads at a higher rank at a lower bid price. For example, Health Score 510, 514 may be used to choose or tune landing pages, and the creative for the ad, so that an ad ranks higher at a given bid price, or maintains rank at a lower bid price.

### V.B. Inputs, Outputs, Process

The following information may be gathered from the advertiser/client, and may be useful either as input to the Health Score, or as background information for use in evaluating recommendations and output from the Health Score:
a list of essential two-letter words that might appear in the creative. For example, for car-selling advertisers, words like ‘GT’ or ‘LX’ are important part of the creative.
a list of brand campaigns/ad groups. Brand terms have different search engine requirements and searchers use them differently to generic terms. For example, click through rates for brand terms are typically higher than for generic terms.
a list of competitor's keywords (or ad groups that contain them) that are in the campaign. To avoid penalizing advertisers for bidding on the competitors' keywords, a database of all such keywords may be assembled, so that the keywords presented to the search engine do not bid on disallowed keywords.
a list of “call to action verbs” that are relevant. For example, the word “buy” would be relevant to a retail advertiser, and “rent” would be applicable to a car-rental advertiser.
a list of words that are prohibited from appearing in the creative. If an advertiser/client mandates avoiding certain words or phrases (like “free credit report”), the advertising agency or other author of a creative should receive a warning.
the level of control over landing pages. Where an advertiser has a low degree of control of the landing pages, the Health Score may give smaller weighting to the Landing Page Subscore.
a list of word pairs that should not appear together in the creative. For example, if creative is selling vans, the creative should not use the word “truck.”
a list of intentionally misspelled keywords and/or list of most common misspellings of the brand name and/or products.
a threshold for the keyword inclusion into the calculation of the scores. There may be a default value, such as 30 clicks for the last 30 days. The threshold may be used to filter out less important keywords (based on the search volume).

By default, Health Score only looks at the keywords that had at least 30 clicks in the last 30 days. These numbers can be changed depending on the media managers need to see more or fewer keywords and/or to adjust a look-back window.

The Health Score may be composite of a triplet: the keyword, creative (ad copy), and the landing page, and may be accumulated from three groups of subscores, which in turn roll up dozens of subscores, which in turn are chosen to track (as accurately as can be determined) the factors that influence the search engine's own Quality Score. The Health Score may be rendered as a number between 1 and 100. Examples of the three subscores are shown in FIGS. 5a and 5b.

### V.C. Creative Subscore of the Health Score

The Creative Subscore may measure the relevance between the keyword and the creative. In paid search advertising, the term “creative” or “ad copy” refers to the text of the ad.

The Creative Subscore may be calculated using six components and two override flags. The Creative Subscore may be computed as the weighted average (current weights are in parenthesis below) of six components. If one of the flags is present, the Creative Subscore may be set to zero.

$$Creative Score ≅ ( {\sum }_{l} {Weight}_{l} \times {Factor}_{l} ) \times Red Flag$$

Two red flags are implemented:
   presence of prohibited terms in the creative
   missing creative
Components (all are on 0-100 scale):
   Exact Keyword Count: This scores the number of appearances of the exact copy of the keyword in the creative.
   Keyword Density:
      Computes the relative portion of the creative that is taken up by the keyword, scaled so that if the keyword occupies about an optimal portion of the creative, then the component will be set 100 points.
   Line One Punctuation:
      Scores the appropriate use of punctuation at the end of the first line
   CTA (Call to Action):
      Scores the use of call to action verbs.
   % of KW Parts Present:
      For the compound keyword, i.e. keywords that have more than one part, what percent of those parts is present in the creative? For example, for the keyword “blue jeans” and the creative “Buy jeans at my store”, this component may be equal to ½ since only one word (jeans) out of two is present in the creative.

In addition, the Health Score software may compute several other flags that may not be included into the Health Score per se, but may be reported to the advertiser/client, or used in the Health Report:
Presence of two words that should not appear together in the creative (like “car” and “van”, “free” and “credit”, etc).
Appearance of the expired offers in the creative.

There are also some exceptions that are built into the algorithm.
Dealing with Keywords that Belong to Competitors. The Creative Subscore may be computed differently for keywords that contain a brand name that does not belong to the advertiser. Often such a brand name is the legal property of a competitor. Search engines may allow keywords that do not contain a brand name or else contain a brand name of the advertiser to also contain the advertiser's brand name in the creative. Search engines may, as a matter of policy, not allow advertisers to use the brand name of a competitor in their ad copy. Search engines may allow advertisers to bid on keywords that contain a competitor's brand, but not allow that brand term to appear in the ad copy. The Creative Subscore for keywords that contain a competitor's brand name may be reduced when the competitor's brand term appears in the associated creative.
Long Keywords. If the length of the keyword is longer than some threshold, such as 17 characters, it becomes unlikely that the whole keyword will appear exactly in the creative. This exception will give “partial credit” to long keywords.

### V.D. Click-Through Subscore

The Click-through Subscore measures the difference between the actual click through rate of the keyword or creative with the expected (by the search engine) click through rate of that keyword at the given position. The Click-through Subscore may be computed daily. The Click-through Subscore may be calculated using the following formula:

$$CTR Score ≅ min ( κ \cdot \frac{CTR}{𝔼 ( CTR )} \cdot 100 ) ,$$

where
6. is a scaling factor and it is the value of the score for which CTR is equal to the expected CTR, E(CTR).
7. CTR the click-through rate, computed for some period of time, for example daily—the CTR may be the number of clicks divided by the number of impressions in a time period.
8. E(CTR) is the expected CTR for the given paid search rank. The curve may be advertiser and campaign specific. It may be an approximation of the expected click through rate for the given type of keywords and the given rank as computed by Google, Microsoft Bing, and Yahoo.

The CTR (item 7 in the above list) is the actually-measured ratio of clicks to searches. So if 10% of searches result in clicks for a keyword at rank 2 but the general expectation (taking into account client and keyword) is that the CTR should be around 15%, then Google's Quality Score will drop. The computation of the Click-through Subscore may be designed to mimic this by
1. Computing a guess of expected CTR for each rank for this keyword and advertiser
2. Comparing the expected CTR to actually observed CTR to get a Click-through Subscore

A Click-through Subscore of 75 indicates that the keyword is behaving as expected. Scores above that threshold suggests a better than expected performance. Click-through Subscores below 75 indicate that some investigation is warranted, and that keyword performance might be improvable by some tuning. If the Click-through Subscore and Creative Subscore are both low, then the most likely explanation for the low Click-through Subscore is a poorly designed creative. On the other hand, if the CTR is low but the Creative Subscore is high, then likely explanations might include:
Low brand association with the particular product or ser vice: customers might not know, or may not trust, the brand on the particular product, hence reducing the CTR.
Above average competition from other bidders.
High volume of impressions for an unrelated search. For example, the keyword ‘+Lee’ (as in Lee jeans) might produce many searches (i.e. impressions) for Bruce Lee, the movie actor. That might drop CTR (and hence Click-through Subscore). The solution might involve including negative matches terms

### V.E. Landing Page Subscore

The LP (Landing Page) subscore is computed every two weeks, unless the landing page URL changes. Landing Page Subscore does three things:
1. Serves as a URL validator (checks return codes, load time, validity of redirects, etc),
2. Measures the relevancy of the landing page to the searched keyword, and
3. Checks whether the page adhere to the best practices guide developed by an SEO (search engine optimization) team.

The Landing Page subscore may be computed by a formula similar to that used for the Creative Subscore:

$$LP Score ≅ ( {\sum }_{l} {Weight}_{l} \times {Factor}_{l} )$$

where Factorsᵢ may include
1. Appearance of the keyword, call to action verbs and company name in the page title
2. Response time performance of the landing page. Pages that load fast score high, and the credit declines as the load time of the pages increases.
3. Appearance of the keyword, its parts, or variations in anchor text or URL structure.
4. Appearance of the keyword, its parts, or variations in the meta tags.
5. Appearance of the keyword, its parts, or variations in the landing page content and page metadata:
   a Appearance of the keyword, its parts, or variations in the content of the anchor text linking.
   b Appearance of the keyword, its parts, or variations in URL Structure.
   c Content and structure of the meta keyword tag:
      i appearance of the keyword, its parts, or variations in the content,
      ii there should be at most 10 keywords present in the tag,
      iii there should be no more than 3 repeats of any of the words.
   d Content and structure of the meta description tag:
      i length should be between 175 and 220 characters,
      ii appearance of the keyword, its parts, or variations in the tag.

### V.F. Health Score

The Health Score may be a weighted average of three subscores (Landing Page Subscore, Click-through Subscore, and Creative Subscore):

HealthScore [symbol] Weight₁×LP Score+Weight₂×Creative Score+Weight₂×CTR Score

The weights may be set specifically for each advertiser/client. For example, for accounts that have very little or no control over the landing pages, the Landing Page Subscore weight might be set to a low value. The health score tracks the overall relevance of the triplet (keyword, creative, landing page) and the quality of each piece (creative and landing page). In addition, performance (CTR) is compared to the expected CTR.

### V.G. Google's Quality Score

A database within the Health Score monitor may store the history of Google's Quality Score for each keyword in the account and track any changes to quality score over time. Google uses this score to determine actual CPC that advertisers pay. The Health Score system may have display pages to display the Google Quality Score and Health Score to a user. For consistency of display, the Google Quality Score—which ranges from 1 to 10—may be rescaled from 10 and 100. Keywords from search engines other than Google (Bing, Yahoo) may be treated differently, for example by being set to zero.

### V.H. Rolling up the Subscores up the Ad/Ad Group/Campaign/Account Hierarchy

The subscores are rolled up the hierarchy from ad, to ad group, to campaign, to account using weighted averages. The weights may be computed using the impressions share index. Hence, the Creative Subscore of the ad group may be computed as a weighted average of the Creative Subscores of all the keywords that belong to that ad group and meet the inclusion threshold.

### V.I. Opportunity Index

The Health Score software may compute an Opportunity Index for each keyword, ad, ad group, campaign, or account. A set of Opportunity Index values will have some outlier values, and those outlier values indicate where effort in tuning the ad is most likely to result in improved Health Scores, therefore improved search engine Quality Score, and therefore higher rank per dollar of spend. Thus, when viewing the Opportunity Index values for the ad groups of a campaign, the few ad groups with the highest Opportunity Index values are the ad groups with the most opportunity for improvement at the least effort.

Opportunity Index may be computed as a number between zero and one hundred representing prioritization order. Improvements to the items with the higher opportunity index should result in a larger impact on the account. “Impression share index” measures the contribution of the particular ad group to the overall campaign total,

$$Impressions Share {Index}_{ad group} ≅ \frac{{Impressions}_{ad group}}{{Impressions}_{campaign}}$$

Opportunity Index measures the opportunity to improve Health Scores for the indexed sets of ads, weighted by the importance (i.e. impressions share index):

Opportunity [symbol] (1−Health Score)×Impressions Share Index

Thus, in our example, we get the following numbers:

| | Health | | Impressions | |
|---|---|---|---|---|
| Ad group | Score | Impressions | Share Index | Opportunity |
| Ad group #1 | 80 | 1,000 | 31% | (100 − 80) * 0.31 = |
| | | | | 6.20 |
| Ad group #2 | 80 | 1,200 | 38% | (100 − 80) * 0.38 = |
| | | | | 7.60 |
| Ad group #3 | 75 | 1,000 | 31% | (100 − 75) * 0.31 = |
| | | | | 7.75 |

Finally, we order ad groups by their opportunity and report the order number (renormalized to be between zero and 100) as an opportunity index.

| Ad | Health | | Impressions | | Opportunity |
|---|---|---|---|---|---|
| group | Score | Impressions | Share Index | Opportunity | Index |
| Ad | 80 | 1,000 | 31% | 6.20 | 33 |
| group | | | | | |
| #1 | | | | | |
| Ad | 80 | 1,200 | 38% | 7.60 | 67 |
| group | | | | | |
| #2 | | | | | |
| Ad | 75 | 1,000 | 31% | 7.75 | 100 |
| group | | | | | |
| #3 | | | | | |

If the Opportunity Index for two ad groups that have the same Health Score (ad group 1 and 2), then the one with more impressions (ad group 2) should have a higher Opportunity Index, and higher priority for tuning to improve performance. Moreover, if there are two ad groups with the same number of impressions (ad groups 1 and 3) the one with the lower score (ad group 3) should get the higher opportunity index.

Referring to FIG. 5c, for a client and account that were previously selected, the client's campaigns, with their Health Scores 520 and Opportunity Index values.

Referring to FIG. 5d, along with the Opportunity Index, the Health Monitor may display a “tool tips” dialog box 530, that helps to diagnose exactly what interventions are most likely to improve the Google quality score. For example, in the following figure:
The ad is displayed, on average, at rank 1.0 (line 532) that is, first on every page where it is displayed.
The ad is displayed for 100% of exact match searches (line 534), but has 0% match for phrase matches and broad matches. With some tuning for broader matching, the ad might be displayed more often.
“Keyword appears exactly” and “Keyword density” are both 0 (lines 536), so this ad could earn a more favorable quality score with attention to embedding the keyword more prominently in the ad

### V.J. Graphical User Interface

A Graphical User Interface (GUI) may be structured to permit navigation and presentation of information about the levels of a paid search account:
Advertiser
Account
Campaign
Ad group
Keyword

To help with identifying areas that need attention, all items in the UI may be color-coded according with the value of the Health Score. In addition, if there are critical issues with the account, the color may be set to red regardless of the value of the Health Score.

V.J.1. Alerts

The Health Score may have a hierarchical system of alerts—that is, alerts may propagate through the account structure. For example, if there is a critical issue associated with the ad group, the alert may propagate up through levels of the account above the ad group—campaign, account, and advertiser. The list of alerts may be customized to the advertiser, and there may be system-wide defaults that are implemented for all advertisers. The status may be set to red if any of the following events happen:
Keyword Level: the final HTTP response code of the landing page for the given keyword is not 200 (i.e. page did not load).
Ad Group level: the number of active creatives is zero for the given ad group.
Account level: an inconsistent use of Server Side Redirects.

V.J.2. Hierarchical Performance Graphs

In FIG. 5e, a screen shows a 30-day graph for a campaign, with summary information, showing the Google Quality Score (540, in deep purple), the Health Score (542 in light blue), and the total number of clicks (544, in red). By default, the last 30 days are shown in the graph. A user may select which metrics and/or subscores to be shown. In addition, the date range can be changed.

FIG. 5f shows the same plot, with control check boxes 560 that allow a user to select the elements to be displayed:

V.J.3. Pop-Up Tips

All throughout the account structure, a user can click on the Health Score bar (see the picture below) to get the detailed breakdown of the score and some additional information.

### V.K. Health Reporting Portal

The Health Reporting Portal may assemble account problems, issues, and unusual events into one place. The Health Report Sub-system may be a separate analytic reporting subsystem. A range of reports can be called from any account level page as shown in the picture.

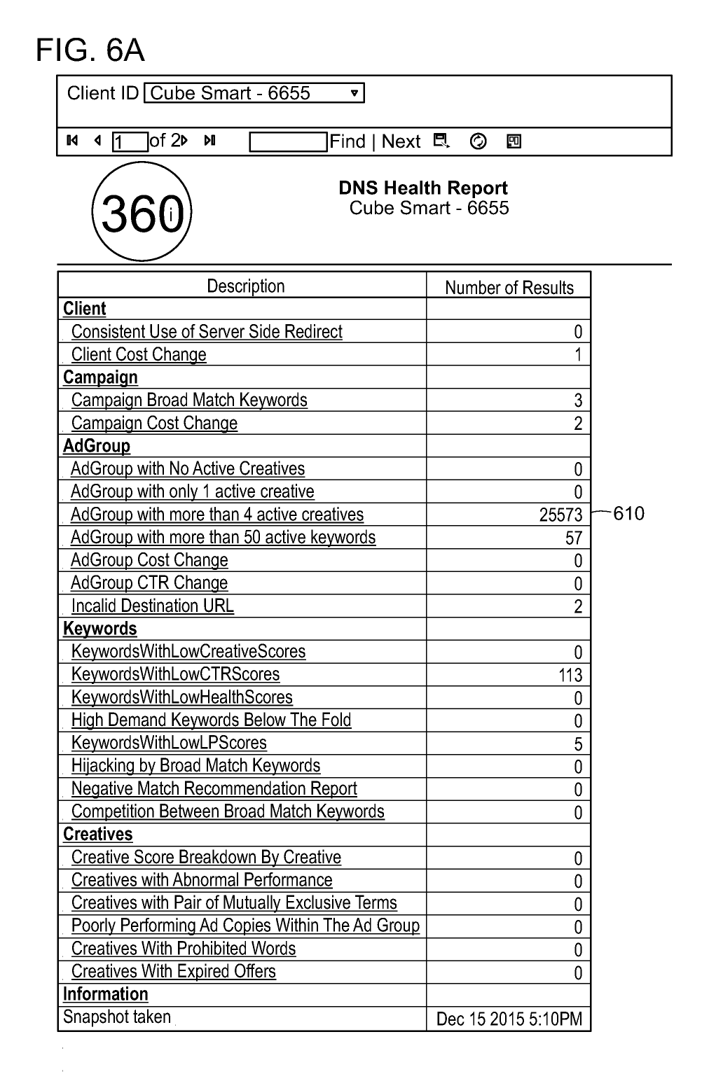

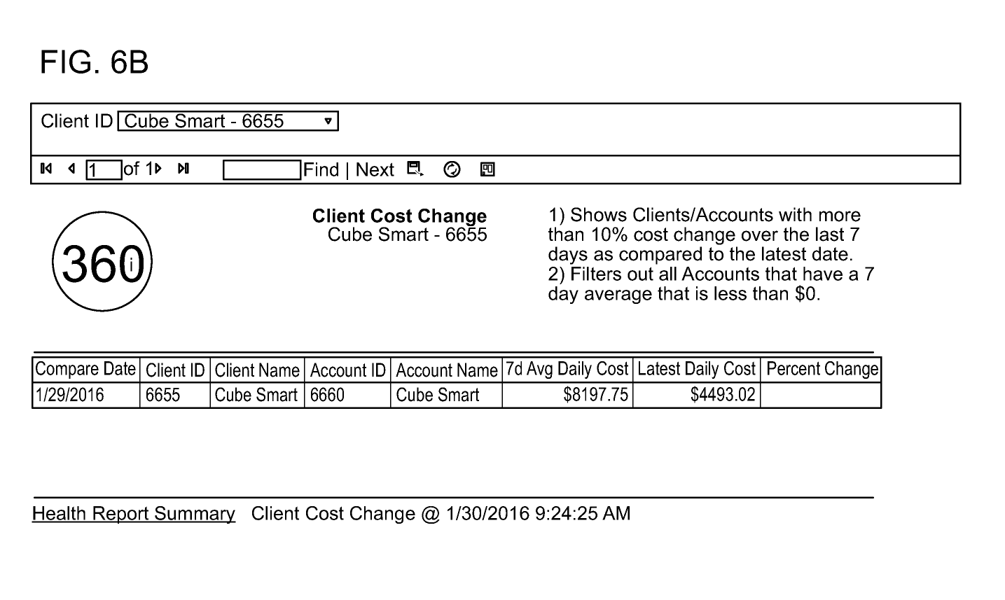

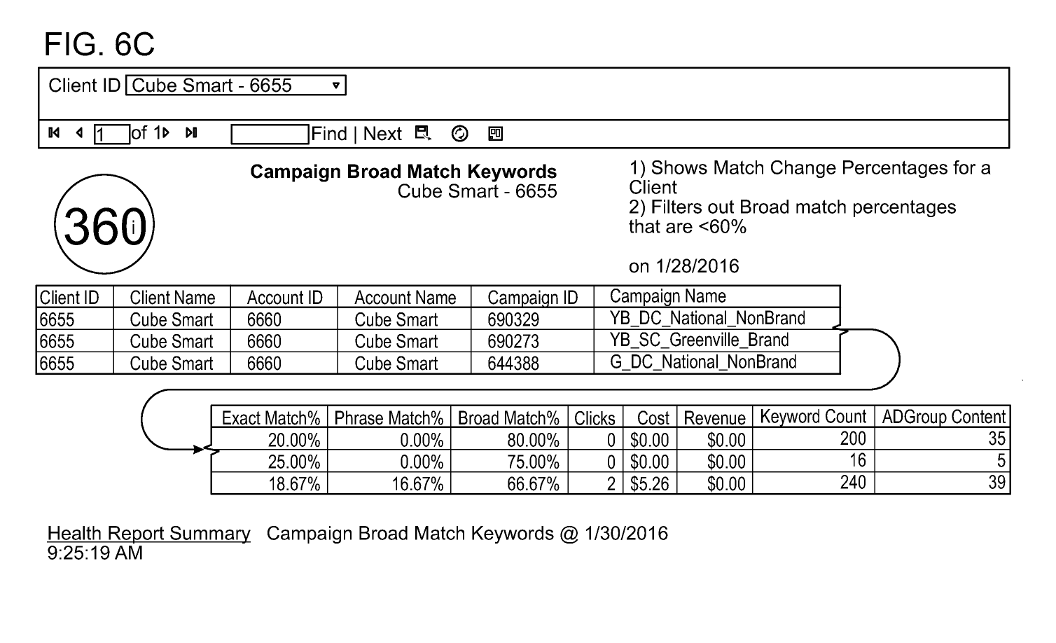

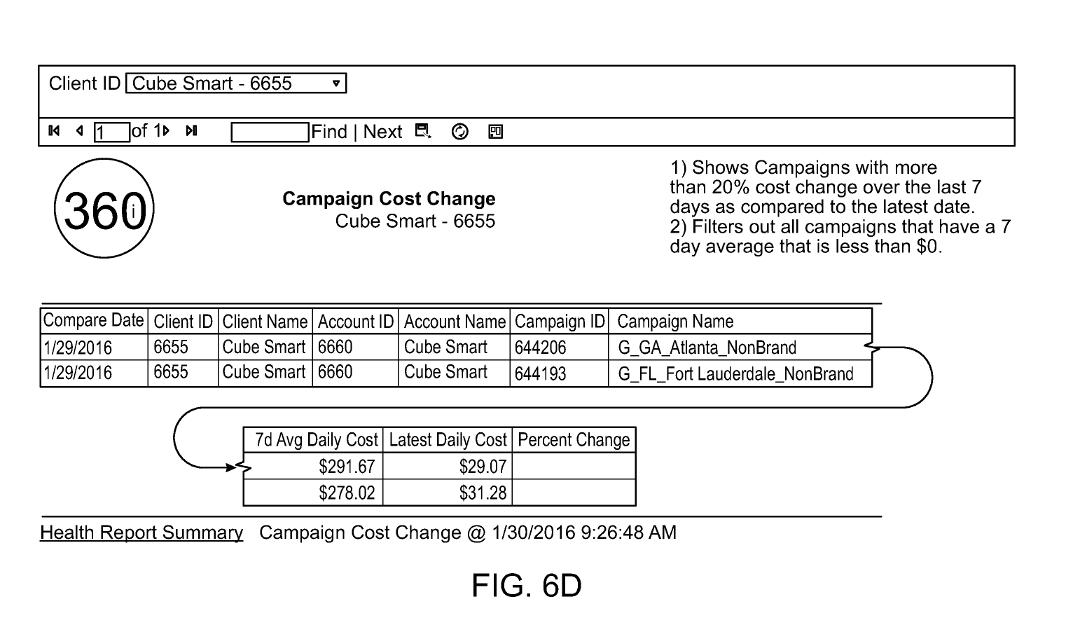

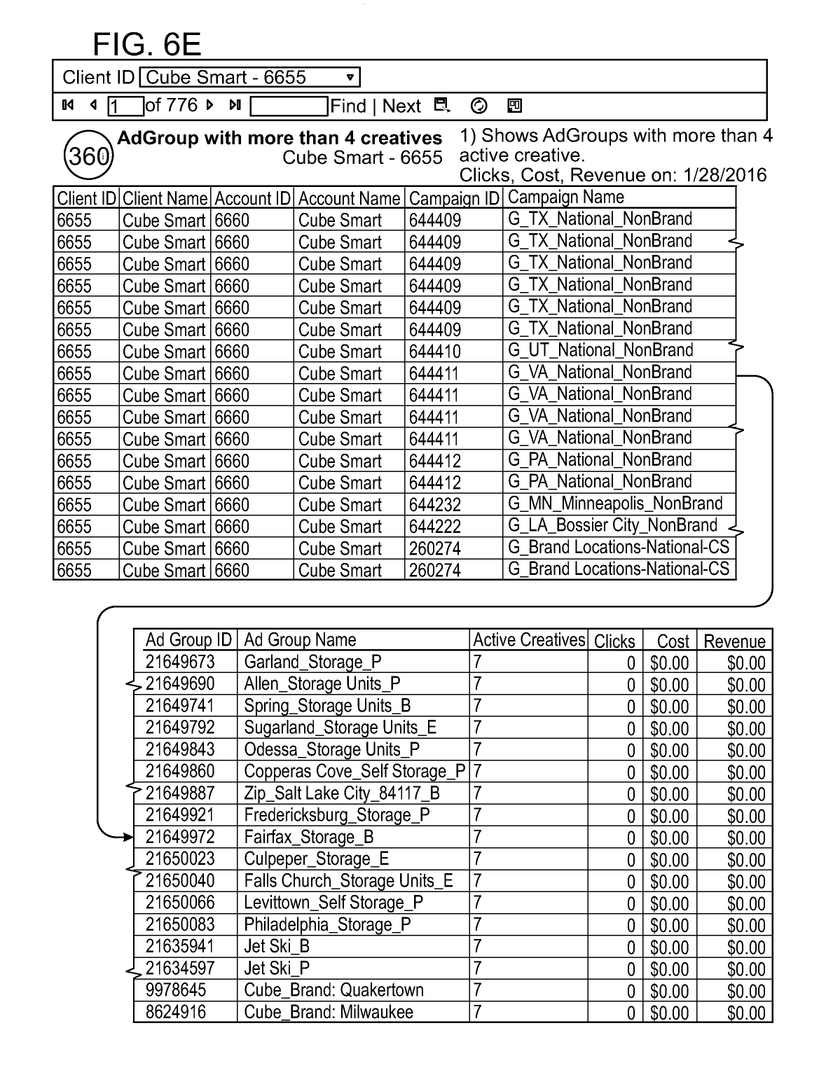

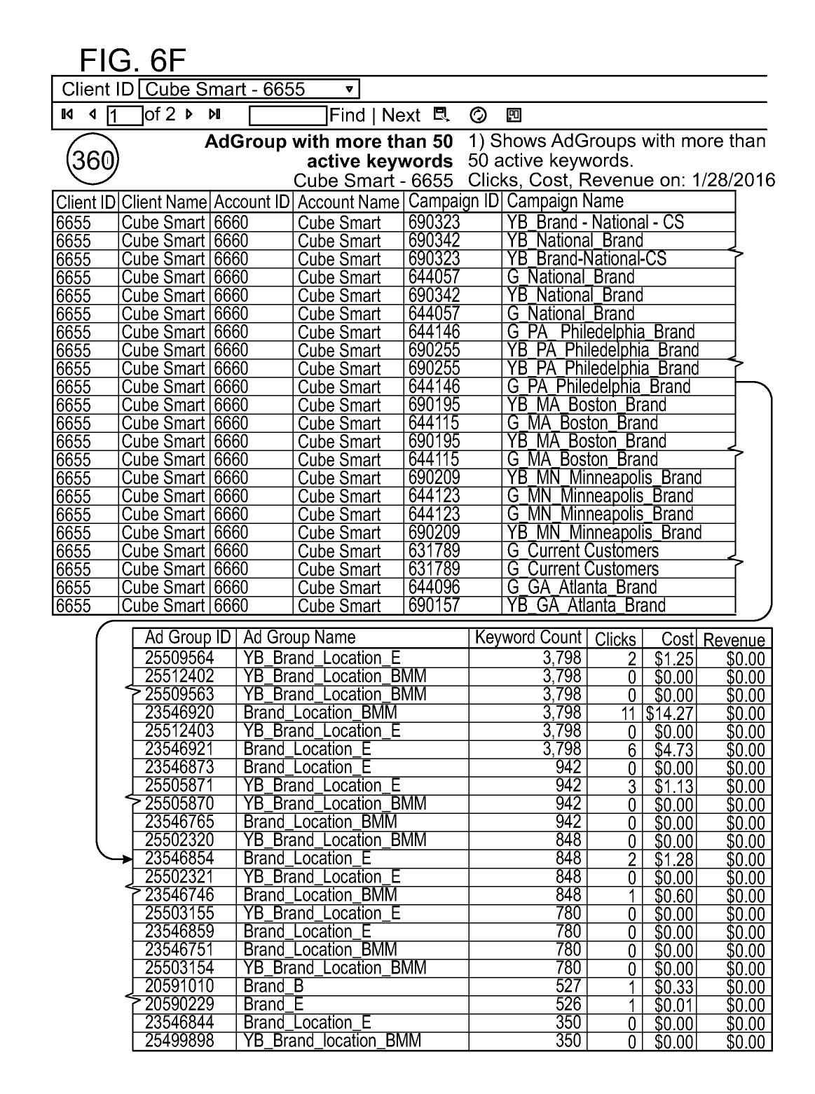

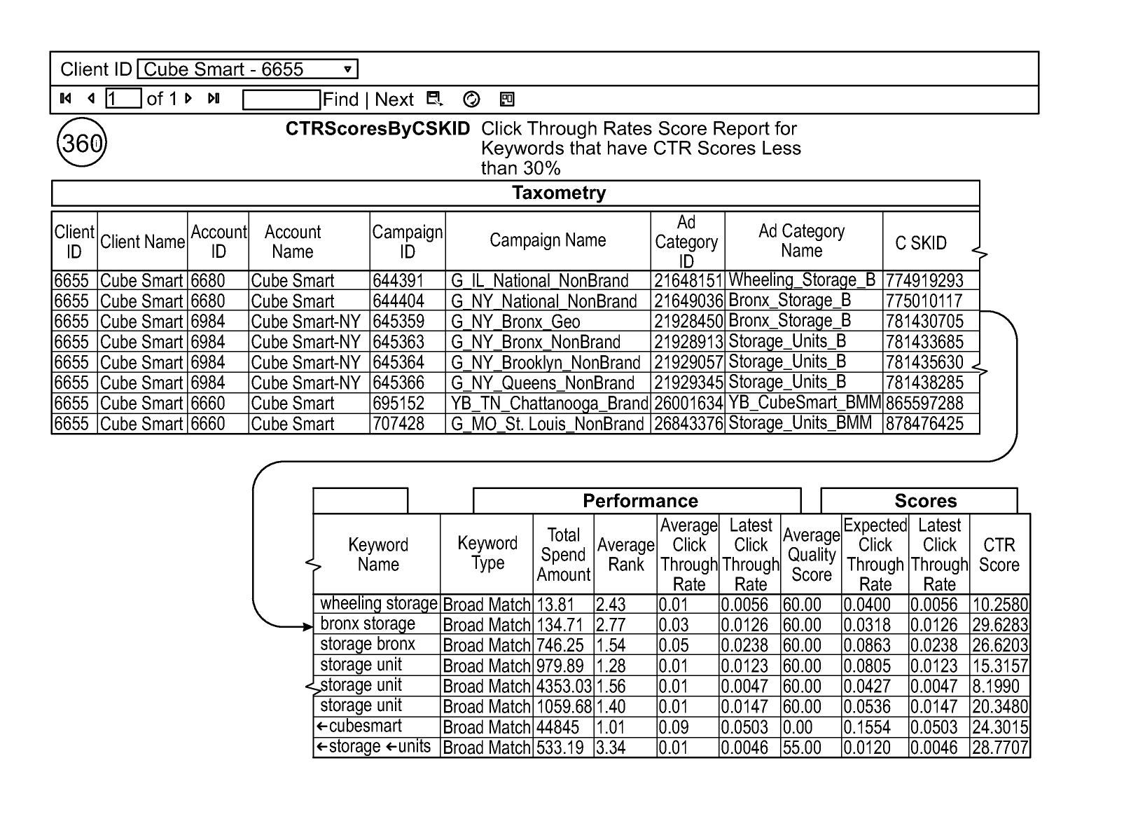

FIG. 6a demonstrates a list of specific reports along with an indication of the quantity of issues the report will deliver information related to. For example, line 610 shows that there are 25,573 ad groups with more than four active creatives. The Health Report Subsystem delivers output reports in Microsoft Excel, Adobe PDF or .csv formats to support flexible analysis and ease of sharing data. The Health Reporting Portal may be implemented in Microsoft Reporting Services or alternatively in Tableau or other Business Intelligence tool.

The Health Report may provide reports that track and/or diagnose potential issues with the account:
Account Level
   List of accounts with abnormal cost change;
   List of accounts that inconsistently use Server Side Redirects at the campaign level.
Campaign Level
   List of campaign with high percentage of broad match keywords;
   List of campaigns with abnormal cost change.
Ad Group Level
   List of ad groups with abnormal cost change;
   List of ad groups with only 1 active creative;
   List of ad groups with more than 4 active creatives;
   List of ad groups with more than 50 active keywords;
   List of ad groups with no active creatives;
   List of ad groups with invalid landing pages' URLs;
   List of ad groups with abnormal CTRs.
Creative Level
   List of Creative Subscore break down by creative;
   List of creatives with abnormal performance.
   List of creatives that contain a pair of mutually exclusive terms;
   List of creatives that contain prohibited words;
   List of creatives with expired offers;
   List of poorly performing ads within the ad group.
Keyword Level
   List of keywords with abnormal Google's quality score change;
   List of keywords with Google's quality score less than 3;
   List of hijackings by broad match keywords;
   Negative match recommendation report;
   List of keywords with low Click-through Subscores;
   List of keywords with low Health Scores;
   List of keywords with low Landing Page Subscores.
   List of high demand keywords with poor SEM ranking.

Referring to FIG. 6b, a report may show ads or keywords that have changed by a large fraction relative to some previous period, such as relative to a seven-day moving average:

The Google user interface permits keywords to be specified either exactly, or with wildcards. There are three main types of match that may be specified.
exact match is an instruction to the search engine ad interface that the ad is only to be displayed if the searcher types exactly the keyword submitted to the search engine.
Phrase match—where the match contains exactly the same words but in various orders
Broad Match—where the match can contain any of the words from the submitted keyword.
   There are variants on these including broad match modifier and negative match which control the sets of matches we want. Negatives are very important for brands because of the use of slang and less than wholesome searches that the brands want no part of.

Referring to FIG. 6c, the Health Reporting system may show how individual keywords are performing under each of these matching criteria. This may help diagnose unexpected matches, and poor performance.

Referring to FIG. 6d, a report may show any campaigns whose overall cost for one time period has changed by a large fraction relative to some previous period, for example, the daily cost for the most-recent week relative to the previous mounth, or for a day relative to the preceding week:

Referring to FIGS. 6e and 6f, reports may show an Ad group with unusually large or small number of creatives, or with an unusually large or small number of active keywords.

Referring to FIG. 6g, a screen may show the click-through rate for each keyword:

### VI. Computer Implementation

Various processes described herein may be implemented by appropriately programmed general purpose computers, special purpose computers, and computing devices.

Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include machine readable, nontransitory, non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

1. A method, comprising the steps of:
by computer, the computer having a processor and nontransitory memory, receiving a list of search keywords, and assessing statistical linguistic similarity among the keywords, using a metric that gives greater weight to linguistic elements that are less frequent in the population of keywords, and balances for greater keyword length and redundancy;
by computer, grouping the search keywords based on the assessed linguistic similarity, the grouping organizing the keywords in a hierarchical subset organization;
for the search keywords that are frequent enough to have historical data from which to estimate performance of the search keywords:
at the computer, receiving information relating to historical expenditure, proceeds, and click performance of the search keywords;
by the computer, computing estimates for the search keywords for a budgeted operation period, the computation using convex constrained mathematical optimization techniques to locate a local maximum of a measure of keyword performance relative to variation in expenditure on search keywords, within a specified budget cap;
for advertising search keywords among a list of advertising search keywords that have historically been too infrequently used to have a statistically sound estimate for value, by computer:
assessing statistical similarity of the sparse-history keyword to other keywords that have sufficient history to support a statistically sound estimate of value,
computing a forecast model by combining past measurements of keyword performance for the historically-supported linguistically similar keywords, including dynamic price behavior of the historically using an algorithm that seeks to minimize total error in the model;
computing estimates for paid advertising to be displayed on search of the sparse-history keyword, using the computed forecast model;
submitting estimates to a search engine for paid search ranking based on search of the sparse-data keyword, at the computed estimate;
dynamically updating the model and updating the estimate for the sparse-history keyword based on ongoing price behavior of the historically-supported linguistically similar keywords;
after estimates are submitted to a search engine for paid search for the sparse-data keywords, updating estimates for the sparse-data keywords by grouping the sparse-data keywords into groups, including at least a high-performing group and a low-performing group, and reallocating budget from the keywords of the low-performing group to keywords of the high-performing group, by reducing estimates for keywords of the low-performing group and increasing estimates of keywords of the high-performing group;
by computer, computing a tracking score that is designed to be a proxy for a quality score computed by a search engine, the search engine using the quality score to for paid search ranking for presentation to users, the tracking score being computed based at least in part on respective search keywords, ad creatives, landing pages for the keywords, and relevance between the ad creative and the content of the landing page;
presenting the tracking score on a display screen, with diagnostic annotation to direct tailoring the a creative and/or landing page to improve the search engine quality score and/or ranking of the creative among paid search results displayed by the search engine in response to the keyword.

2. A method, comprising the steps of:
by computer, analyzing a list of advertising search keywords, and computing bids for keywords of the list, the keywords and bids to be submitted to a search engine to bid for ranking among search results by the search engine for searches on the search keywords;
by computer, for an advertising search keyword from among the list that has little historical data to compute a statistically sound estimate for value by at least the following steps:
from among the search keyword list, identifying keywords that are linguistically similar to the sparse-history keyword and that have sufficient history to support a statistically sound estimate of value, using a metric of linguistic similarity that gives greater weight to linguistic elements that are less frequent in the population of keywords, and balances for greater keyword length and redundancy;
computing a forecast model by combining past measurements of bid performance for the historically-supported linguistically similar keywords;
computing bids for paid advertising to be displayed on search of the sparse-history keyword, using the computed forecast model;
submitting bids to a search engine for paid advertising based on search of the sparse-data keyword, at the computed bid;
dynamically updating the model and updating the bid for the sparse-history keyword based on ongoing price behavior of the historically-supported linguistically similar keywords; and
submitting bids to a search engine for advertising based on search of the infrequent keywords, at the computed bid.

3. The method of claim 2, further comprising the step of:
computing the forecast model by computing parameters of an equation that models movement in the sparse-history keyword based on a sequence of prices of the historically-supported keywords, the model reflecting time-dynamic behavior over a history of the historically-supported keywords.

4. The method of claim 2, further comprising the step of:
computing the forecast model by computing parameters of an equation that models a maximum likelihood of minimizing error in the computation.

5. The method of claim 4, further comprising:
computing parameters of equations of a Kalman filter model or linear quadratic estimation model.

6. The method of claim 2, further comprising the step of:
computing forecast models for a plurality of sparse-data keywords for a future time interval by updating bid prices for the sparse-data keyword computed in a previous time by:
grouping the sparse-data keywords into a plurality of groups, the groups ranked from a high-performing group and a low-performing group, and
reallocating budget from the sparse-data keywords of lower-performing groups to keywords of higher-performing groups, by reducing bid price for keywords of lower-performing groups and increasing bid price of keywords of higher-performing groups.

7. The method of claim 2, further comprising the step of:
computing a metric of linguistic similarity based on Levenshtein distance.

8. The method of claim 2, further comprising the step of:
computing a metric of linguistic similarity based on Jaccard Coefficient distance.

9. The method of claim 2, further comprising the step of:
computing a metric of linguistic similarity based on a combination of two underlying distance metrics.

10. The method of claim 2, further comprising the step of:
computing the model and bids for a plurality that is fewer than all of the sparse-data keywords in the list.

11. A computer, comprising:
a processor;
a memory storing one or more programs, the programs being programmed to cause the processor to:
analyze a list of advertising search keywords, and compute bids for keywords of the list, the keywords and bids to be submitted to a search engine to bid for ranking among search results by the search engine for searches on the search keywords;
for an advertising search keyword from among the list that has little historical data, to compute a statistically sound estimate for value by the following computations:
from among the search keyword list, identify keywords that are linguistically similar to the sparse-history keyword and that have sufficient history to support a statistically sound estimate of value, using a metric of linguistic similarity that gives greater weight to linguistic elements that are less frequent in the population of keywords, and balances for greater keyword length and redundancy;
compute a forecast model by combining past measurements of bid performance for the historically-supported linguistically similar keywords;
compute bids for paid advertising to be displayed on search of the sparse-history keyword, using the computed forecast model;
submit bids to a search engine for paid advertising based on search of the sparse-data keyword, at the computed bid;
dynamically update the model and updating the bid for the sparse-history keyword based on ongoing price behavior of the historically-supported linguistically similar keywords; and
submit bids to a search engine for advertising based on search of the infrequent keywords, at the computed bid.

12. The computer of claim 11, the programs being further programmed to cause the processor to:
compute the forecast model by compute parameters of an equation that models movement in the sparse-history keyword based on a sequence of prices of the historically-supported keywords, the model reflecting time-dynamic behavior over a history of the historically-supported keywords.

13. The computer of claim 11, the programs being further programmed to cause the processor to:
compute the forecast model by computing parameters of an equation that models a maximum likelihood of minimizing error in the computation.

14. The computer of claim 13, the programs being further programmed to cause the processor to:
compute parameters of equations of a Kalman filter model or linear quadratic estimation model.

15. The computer of claim 11, the programs being further programmed to cause the processor to:
compute forecast models for a plurality of sparse-data keywords for a future time interval by updating bid prices for the sparse-data keyword computed in a previous time by:
grouping the sparse-data keywords into a plurality of groups, the groups ranked from a high-performing group and a low-performing group, and
reallocating budget from the sparse-data keywords of lower-performing groups to keywords of higher-performing groups, by reducing bid price for keywords of lower-performing groups and increasing bid price of keywords of higher-performing groups.

16. The computer of claim 11, the programs being further programmed to cause the processor to:
compute a metric of linguistic similarity based on a combination of two underlying distance metrics.
